(19) United States
(12) Patent Application Publication
(10) Pub. No.: US 2014/0355507 A1
(43) Pub. Date: Dec. 4, 2014

(54) ADJUSTING PRIORITY OF MBMS AND FEMTO CELLS

(71) Applicant: QUALCOMM Incorporated, San Diego, CA (US)

(72) Inventors: Daniel AMERGA, San Diego, CA (US); Aziz GHOLMIEH, San Diego, CA (US); Kuo-Chun LEE, San Diego, CA (US); Feilu LIU, San Diego, CA (US); Shailesh MAHESHWARI, San Diego, CA (US); Muralidharan MURUGAN, San Diego, CA (US); Jack Shyh-Hurng SHAUH, San Diego, CA (US); Sivaramakrishna VEEREPALLI, San Diego, CA (US); Jun WANG, Poway, CA (US); Xiaoxia ZHANG, San Diego, CA (US)

(73) Assignee: QUALCOMM Incorporated, San Diego, CA (US)

(21) Appl. No.: 14/210,394

(22) Filed: Mar. 13, 2014

Related U.S. Application Data
(60) Provisional application No. 61/828,158, filed on May 28, 2013.

(51) Int. Cl. H04W 4/08; H04W 36/02; H04W 36/00; H04W 72/00

(52) U.S. Cl. CPC H04W 4/08; H04W 72/005; H04W 36/026; H04W 36/0066
USPC 370/312

(57) ABSTRACT

A UE may camp on a femto cell in an idle mode and determine whether the UE has an interest in receiving an MBMS service from an MBMS cell. When the UE has the interest in receiving the MBMS service, the UE adjusts a priority of the MBMS cell on which the MBMS service is provided or a priority of the femto cell such that the priority of the MBMS cell is higher than the priority of the femto cell. Otherwise, the UE refrains from adjusting the priority of the MBMS cell or the priority of the femto cell.

### CROSS-REFERENCE TO RELATED APPLICATION(S)

This application claims the benefit of U.S. Provisional Application Ser. No. 61/828,158, entitled “ADJUSTING PRIORITY OF MBMS AND FEMTO CELLS” and filed on May 28, 2013, which is expressly incorporated by reference herein in its entirety.

### BACKGROUND

1. Field

The present disclosure relates generally to communication systems, and more particularly, to adjusting priority of Multimedia Broadcast Multicast Service (MBMS) and femto cells.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus are provided. The apparatus may be a UE. The UE camps on a femto cell in an idle mode. The UE determines whether the UE has an interest in receiving an MBMS service from an MBMS cell. The UE adjusts a priority of the MBMS cell on which the MBMS service is provided or the priority of the femto cell such that the priority of the MBMS cell is higher than the priority of the femto cell when the UE has the interest in receiving the MBMS service. The UE refrains from adjusting the priority of the MBMS cell or the priority of the femto cell when the UE does not have the interest in receiving the MBMS service.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7A is a diagram illustrating an example of an evolved Multimedia Broadcast Multicast Service channel configuration in a Multicast Broadcast Single Frequency Network.

FIG. 7B is a diagram illustrating a format of a Multicast Channel Scheduling Information Media Access Control control element.

FIG. 8A is a diagram illustrating an example access network with a MBMS cell and a femto cell.

FIG. 8B is a diagram illustrating example transmissions between a UE and the MBMS and femto cells.

FIG. 9A is a diagram illustrating an example access network with multiple cells in which system information blocks (SIBs) are transmitted.

FIG. 9B is a diagram illustrating example service area identities (SAIs) available at various frequencies based on the transmitted SIBs.

FIG. 10 is a diagram illustrating an example access network in which the UE is camped on the femto cell in the RRC idle mode.

FIG. 11 is a diagram illustrating an example access network in which the UE is communicating with the femto cell in an RRC connected mode.

FIG. 12 is a diagram illustrating an example access network in which the UE is communicating with the MBMS cell in the RRC connected mode.

FIG. 13 is a flow chart of a first method of wireless communication of a UE.

FIG. 14 is a flow chart of a second method of wireless communication of a UE.

FIG. 15 is a flow chart of a third method of wireless communication of a UE.

FIG. 16 is a flow chart of a fourth method of wireless communication of a UE.

FIG. 17 is a flow chart of a fifth method of wireless communication of a UE.

FIG. 18 is a flow chart of a sixth method of wireless communication of a UE.

FIG. 19 is a flow chart of a seventh method of wireless communication of a UE.

FIG. 20 is a flow chart of an eighth method of wireless communication of a UE.

FIG. 21 is a diagram illustrating an example access network in which the MBMS cell communicates with the UE.

FIG. 22 is a flowchart of a method of wireless communication of an MBMS cell.

FIG. 23 is a conceptual data flow diagram illustrating the data flow between different modules/means/components in a first exemplary apparatus.

FIG. 24 is a diagram illustrating an example of a hardware implementation for the first apparatus employing a processing system.

FIG. 25 is a conceptual data flow diagram illustrating the data flow between different modules/means/components in a second exemplary apparatus.

FIG. 26 is a diagram illustrating an example of a hardware implementation for the second apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

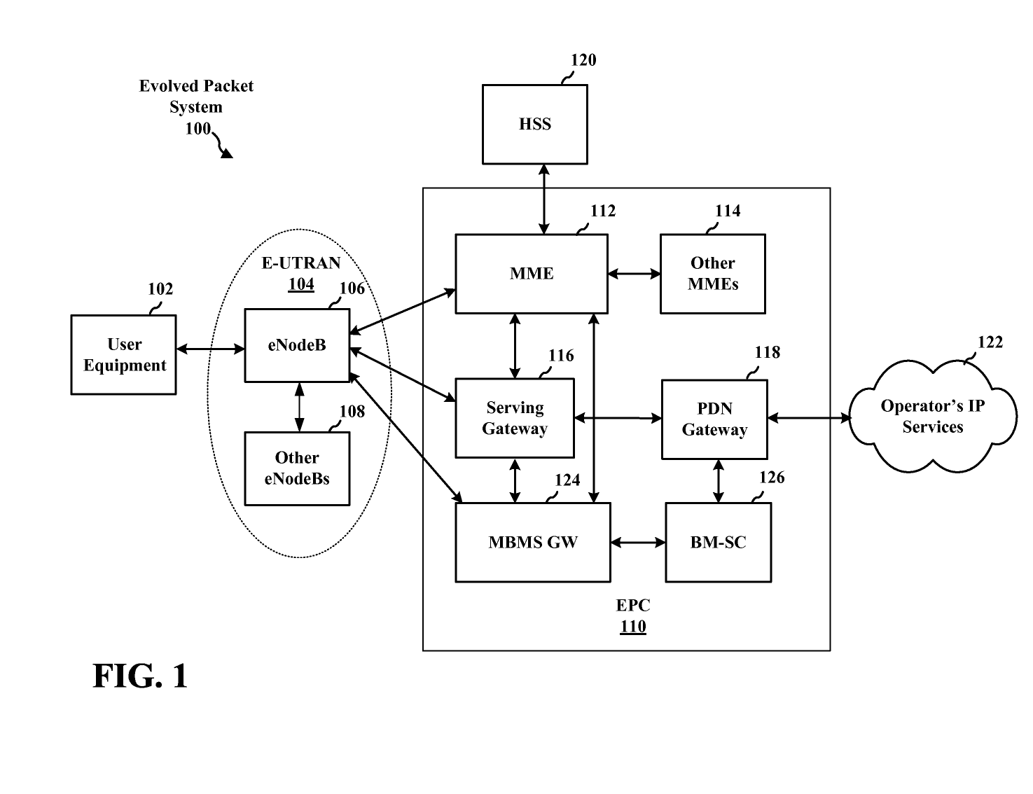

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. User IP packets may be transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, an intranet, an IP Multimedia Subsystem (IMS), and a PS Streaming Service (PSS). The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting evolved MBMS (eMBMS) related charging information.

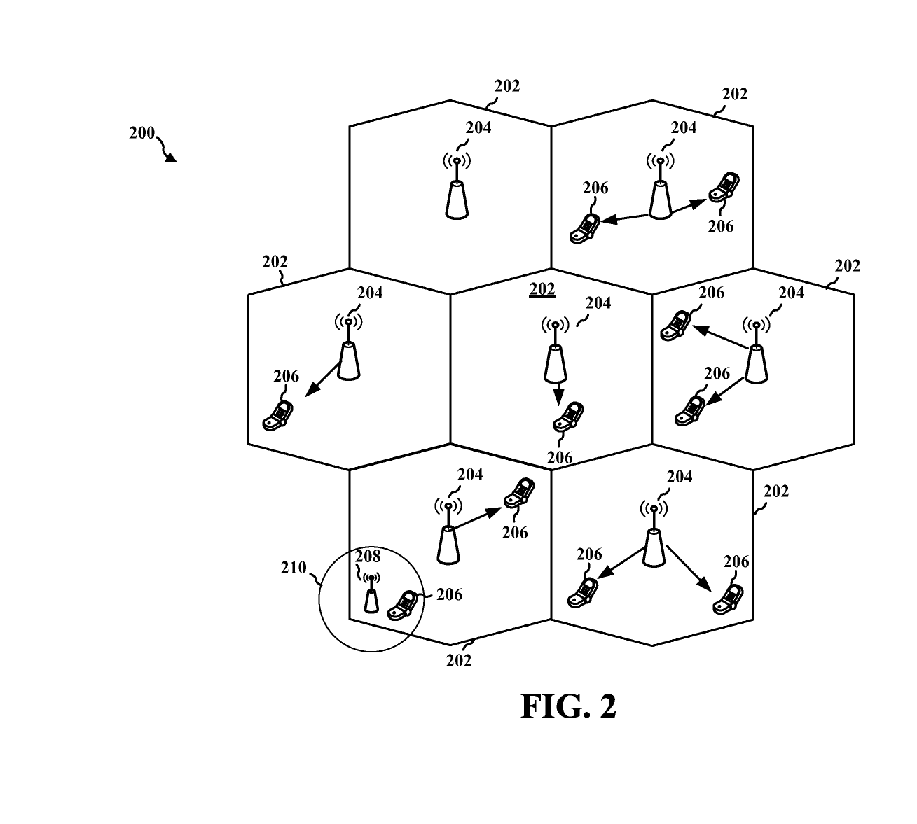

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, a small cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sector). The term “cell” can refer to the smallest coverage area of an eNB and/or an eNB subsystem serving are particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

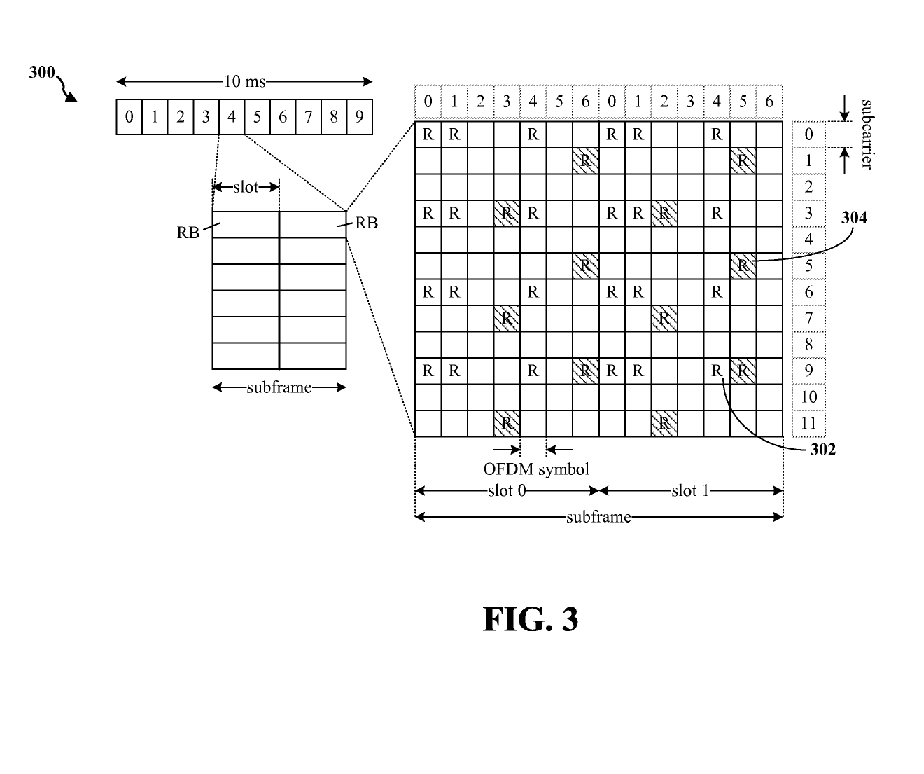

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block may contain 6 consecutive OFDM symbols in the time domain or 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

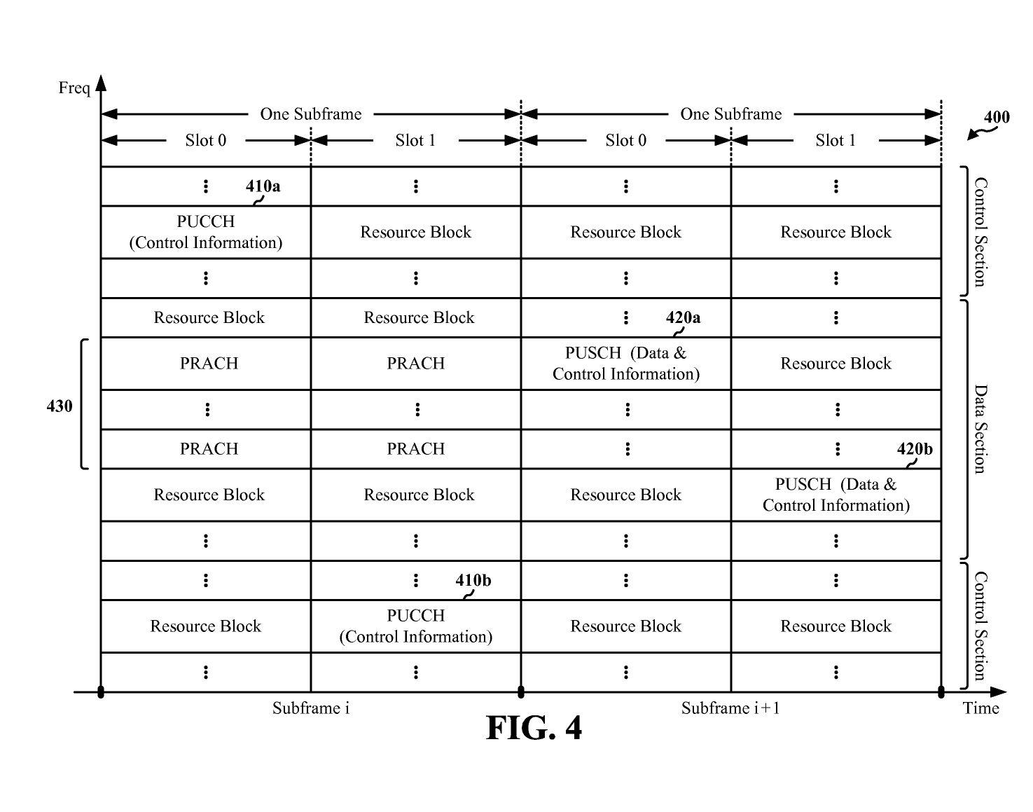

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

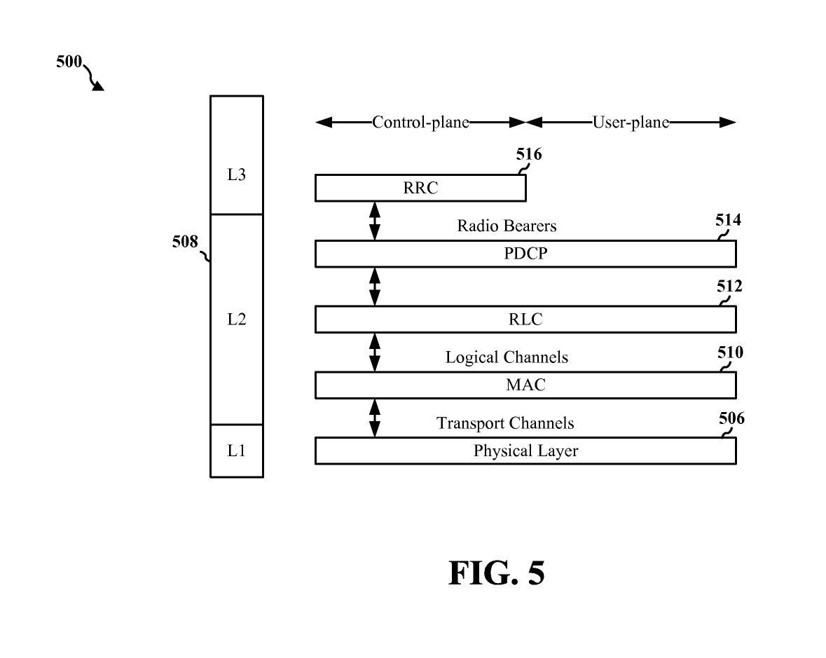

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARM). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

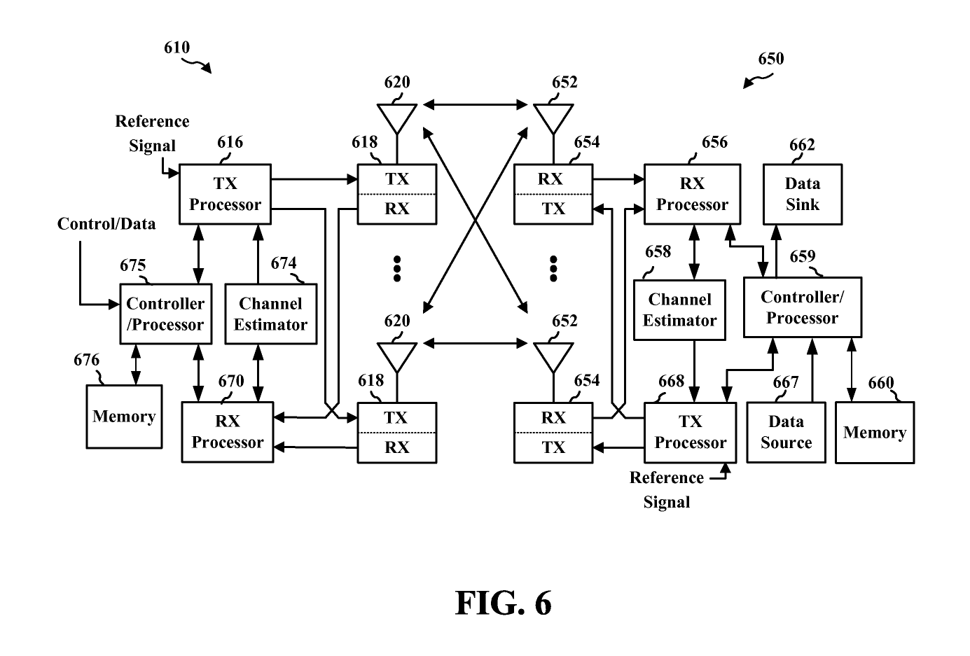

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

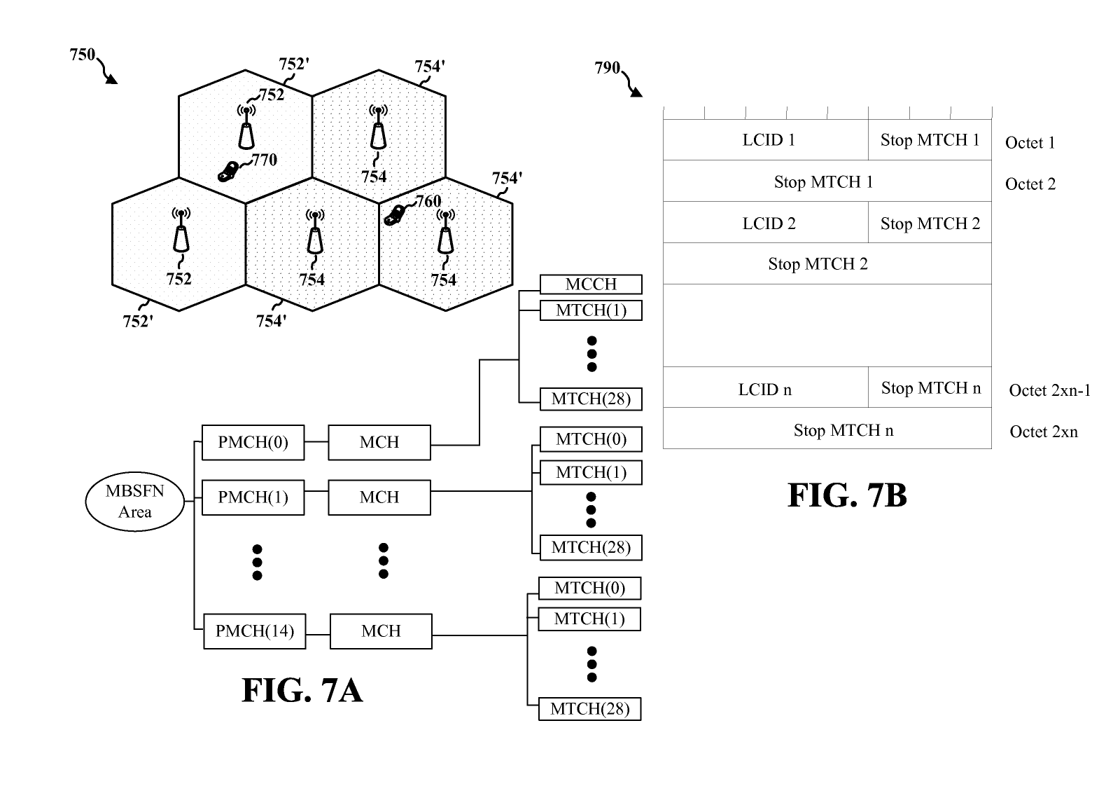

FIG. 7A is a diagram 750 illustrating an example of an eMBMS channel configuration in an MBSFN. The eNBs 752 in cells 752′ may form a first MBSFN area and the eNBs 754 in cells 754′ may form a second MBSFN area. The eNBs 752, 754 may each be associated with other MBSFN areas, for example, up to a total of eight MBSFN areas. A cell within an MBSFN area may be designated a reserved cell. Reserved cells do not provide multicast/broadcast content, but are time-synchronized to one or more of the cells 752′, 754′ and have restricted power on MBSFN resources in order to limit interference to the MBSFN areas. Each eNB in an MBSFN area synchronously transmits the same eMBMS control information and data. Each area may support broadcast, multicast, and unicast services. A unicast service is a service intended for a specific user, e.g., a voice call. A multicast service is a service that may be received by a group of users, e.g., a subscription video service. A broadcast service is a service that may be received by all users, e.g., a news broadcast. Referring to FIG. 7A, the first MBSFN area may support a first eMBMS broadcast service, such as by providing a particular news broadcast to UE 770. The second MBSFN area may support a second eMBMS broadcast service, such as by providing a different news broadcast to UE 760. Each MBSFN area supports a plurality of physical multicast channels (PMCH) (e.g., 15 PMCHs). Each PMCH corresponds to a multicast channel (MCH). Each MCH can multiplex a plurality (e.g., 29) of multicast logical channels. Each MBSFN area may have one multicast control channel (MCCH). As such, one MCH may multiplex one MCCH and a plurality of multicast traffic channels (MTCHs) and the remaining MCHs may multiplex a plurality of MTCHs.

A UE can camp on an LTE cell to discover the availability of eMBMS service access and a corresponding access stratum configuration. In a first step, the UE may acquire a system information block (SIB) 13 (SIB13). In a second step, based on the SIB13, the UE may acquire an MBSFN Area Configuration message on an MCCH. In a third step, based on the MBSFN Area Configuration message, the UE may acquire an MCH scheduling information (MSI) MAC control element. The SIB13 indicates both (1) an MBSFN area identifier of each MBSFN area supported by the cell; (2) information for acquiring the MCCH such as an MCCH repetition period (e.g., 32, 64, . . . , 256 frames), an MCCH offset (e.g., 0, 1, . . . , 10 frames), an MCCH modification period (e.g., 512, 1024 frames), a signaling modulation and coding scheme (MCS), subframe allocation information indicating which subframes of the radio frame as indicated by repetition period and offset can transmit MCCH; and (3) an MCCH change notification configuration. There is one MBSFN Area Configuration message for each MBSFN area. The MBSFN Area Configuration message indicates (1) a temporary mobile group identity (TMGI) and an optional session identifier of each MTCH identified by a logical channel identifier within the PMCH, (2) allocated resources (i.e., radio frames and subframes) for transmitting each PMCH of the MBSFN area and the allocation period (e.g., 4, 8, . . . , 256 frames) of the allocated resources for all the PMCHs in the area, and (3) an MCH scheduling period (MSP) (e.g., 8, 16, 32, . . . , or 1024 radio frames) over which the MSI MAC control element is transmitted.

FIG. 7B is a diagram 790 illustrating the format of an MSI MAC control element. The MSI MAC control element may be sent once each MSP. The MSI MAC control element may be sent in the first subframe of each scheduling period of the PMCH. The MSI MAC control element can indicate the stop frame and subframe of each MTCH within the PMCH. There may be one MSI per PMCH per MBSFN area.

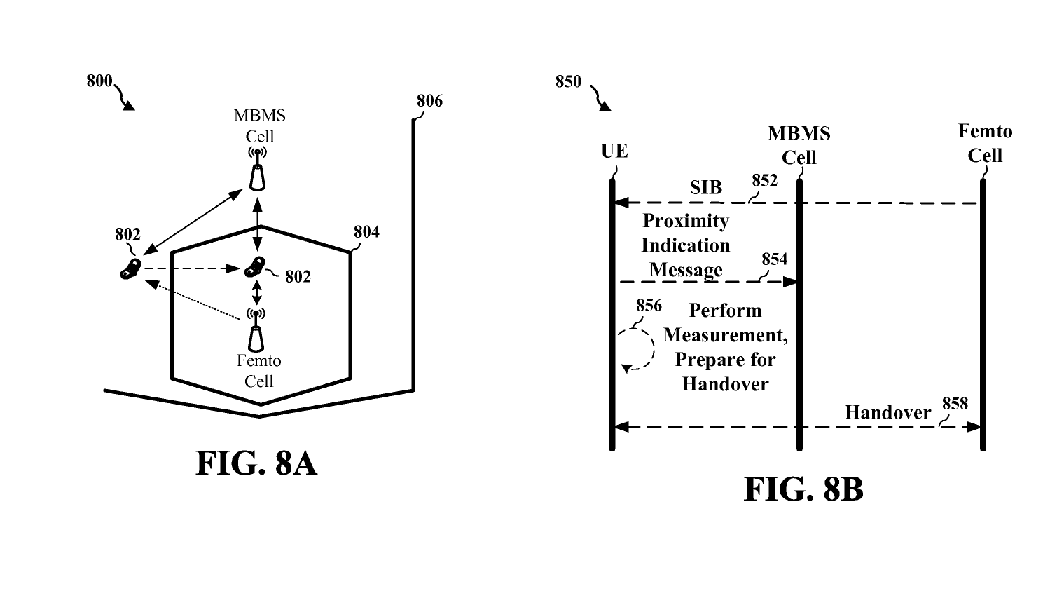

FIG. 8A is a diagram illustrating an example access network 800 with an MBMS cell and a femto cell. The MBMS cell may be a macro cell (e.g., an eNB), a pico cell, or otherwise, a cell of a higher power class than the femto cell. The MBMS cell may serve UEs in the cellular region (also referred to as coverage area or cell) 806. The MBMS cell may provide an MBMS service to the UE 802. The MBMS cell may communicate with the UE 802 when the UE 802 is in the coverage area 806 of the MBMS cell. The femto cell may be a Closed Subscriber Group (CSG) cell, a Hybrid CSG cell, and/or a Home eNB (HeNB). The femto cell may provide closed or hybrid access to certain sets of subscribers with special membership. The femto cell may serve UEs in the cellular region (also referred to as coverage area or cell) 804. The femto cell may communicate with the UE 802 when the UE 802 is in the coverage area 804 of the femto cell. However, the femto cell may not provide MBMS service to the UE 802.

When the UE 802 is inside the coverage area of both the MBMS cell and the femto cell, existing communication standards may require the UE 802 to select (or to reselect) or to prioritize the femto cell over the MBMS cell. That is, existing communication standards may require that the femto cell have a higher priority for the UE 802 than the MBMS cell. If the UE 802 is interested in receiving an MBMS service (e.g., interested in continuing to receive a currently received MBMS service or interested in receiving a future MBMS service) from the MBMS cell, and the UE 802 is required to select the femto cell upon entering the coverage area 804 of the femto cell, the UE 802 may be unable to continue receiving an MBMS service of interest or to receive in the near future the MBMS service of interest. As such, selection or prioritization of the femto cell over the MBMS cell may not be preferred, such as when the UE 802 is interested in receiving (continuing to receive or receiving in the near future) an MBMS service from the MBMS cell. As will be discussed in further detail infra, when the UE 802 is within the coverage area of the MBMS cell and the coverage area of the femto cell, the UE 802 may determine whether the UE 802 has an interest in receiving the MBMS service and adjust a priority of the MBMS cell or the priority of the femto cell based on the determination of whether the UE 802 has the interest in receiving the MBMS service.

FIG. 8B is a diagram 850 illustrating example transmissions between the UE and the MBMS cell and femto cell. The UE may initially be within the coverage area of the MBMS cell but not within the coverage area of the femto cell. The femto cell may periodically broadcast system information (e.g., SIB1). At 852, when the UE enters into the coverage area of the femto cell, the UE may receive the system information (e.g., SIB1) from the femto cell. The system information (e.g., SIB1) may contain the femto identity of the femto cell and may also contain a femto-indication that has a value that may be set to TRUE or FALSE (or alternatively may be set to 1 or 0). If the system information (e.g., SIB1) has a femto-indication value set to TRUE and contains a particular 27-bit femto identity, e.g., 00000000 00000000 00000000 001, then the UE may know that the system information (e.g., SIB1) was sent by a CSG femto cell. If the system information (e.g., SIB1) has a femto-identity value set to FALSE and contains a different 27-bit femto identity, e.g. 00000000 00000000 00000000 010, then the UE may know that the system information (e.g., SIB1) was sent by a Hybrid femto cell.

The UE may read system information (e.g., SIB1) to obtain information relevant to access parameters for a particular cell (e.g., the femto cell). SIB1, for example, can be broadcast to convey common information to all UEs in a particular cell (e.g., the femto cell) as related to cell access parameters and information related to scheduling of other SIBs. SIB1 contents may assist the UE when the UE is evaluating cell access and may also define the scheduling of other system information. For example, SIB1 may be broadcast every 80 ms in subframe 5 in frames with even system frame numbers (SFNs). Although SIB1 is described as one example of system information, system information can be included in other SIBs. SIB15, as discussed infra, is another example of system information. It will be understood by one of ordinary skill in the art that any reference herein to a SIB is merely for illustrative purposes and is not to be construed as a limiting embodiment of system information.

At 854, the UE may transmit a proximity indication message to the MBMS cell. In one example, the UE may transmit the proximity indication message if the UE enters the proximity of one or more cells whose CSG identifications (IDs) are in the UE's CSG whitelist on a E-UTRA/UTRAN frequency. In another example, the UE may send the proximity indication message if the UE leaves the proximity of all cells whose CSG IDs are in the UE's CSG whitelist on the E-UTRA/UTRAN frequency. In response to the UE sending the proximity indication message to the MBMS cell, the MBMS cell may request that the UE measures a signal quality from the femto cell. If the signal quality is greater than a threshold, the MBMS cell may request the UE to prepare for a handover to the femto cell. Accordingly, at 856, the UE may perform measurements and prepare for a handover to the femto cell. At 858, the MBMS cell may hand off the UE to the femto cell.

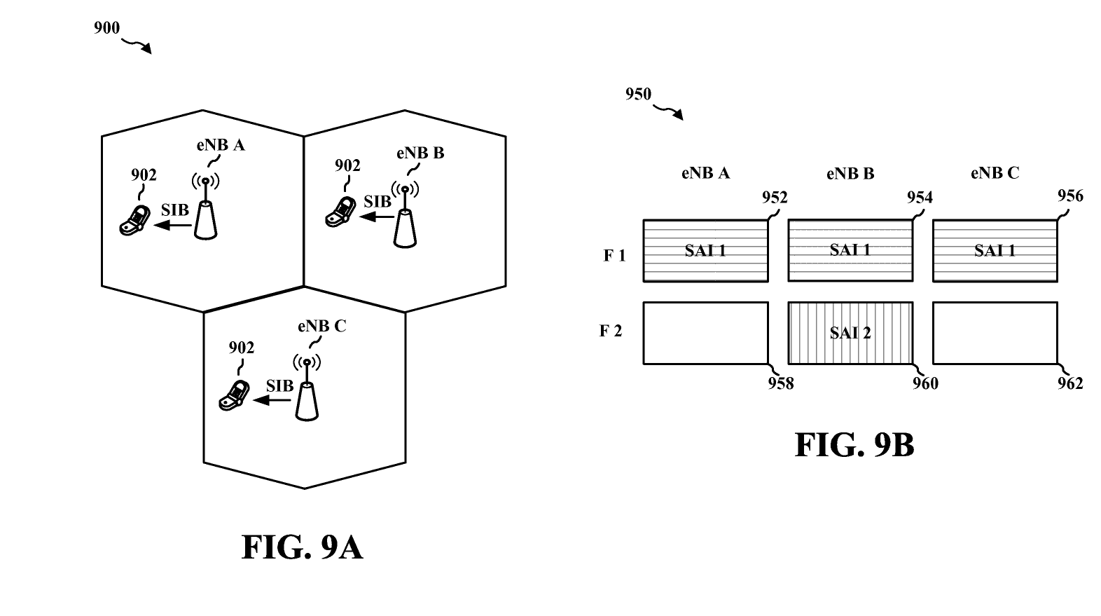

FIG. 9A is a diagram illustrating an example access network 900 with multiple cells in which various SIBs are transmitted. The eNB A, the eNB B, and the eNB C may transmit system information (e.g., SIB15) to a UE 902 located inside the eNB's respective coverage area. The system information (e.g., SIB15) may contain information about the SAIs available from each eNB at various frequencies (e.g., F1, F2). An SAI may indicate one or more cells in a coverage area that broadcasts the MBMS service. If the SAI(s) broadcast in the SIB15 is included in the SAI list of the User Service Description (USD) for a particular Temporary Mobile Group Identity (TMGI), the UE 902 may determine that the MBMS service of that TMGI is available in the current coverage area of the respective eNB. The eNB may be on the frequency that is associated with the SAI.

The UE 902 may receive the USD indicating available MBMS services and the TMGIs and SAIs associated with the available MBMS services. An eNB may broadcast system information (e.g., SIB15) to indicate the SAIs that are available at the current frequency (e.g., the frequency on which the SIB15 was broadcast) and at neighboring frequencies. Accordingly, based on the received USD and system information, a UE may be able to determine MBMS services that the UE can receive from the eNB. The USD provides a list of TMGIs and for each TMGI a corresponding list of SAIs that carry the TMGI. The SIB15 provides a list of SAIs on the current frequency and neighbor frequencies, if any. The service of interest to the UE is identified by a particular TMGI. To determine if a current cell has the service of interest, the UE determines the TMGI for a service of interest, uses the USD to determine SAIs that offer the TMGI, and uses the SIB 15 information to determine frequencies offering the SAI(s) with the TMGI. When the UE 902 is interested in an MBMS service available on one of the frequencies associated with the indicated SAIs, the UE 902 may send an MBMS interest indication message to indicate such interest to a serving eNB. The serving eNB may then hand over the UE to the cell on the frequency of interest. Further, if the UE is receiving an MBMS service at the current frequency, the UE may send an MBMS interest indication message indicating an interest in receiving or remaining on the current frequency so that the network does not configure parameters that affect service reception.

FIG. 9B is a diagram 950 illustrating example SAIs available on various frequencies based on the SIB transmitted by a corresponding eNB. For example, based on the SIB transmitted by the eNB A to the UE in the coverage area of eNB A, the UE may determine that SAI 1 is available on a first frequency F1 (box 952) and, further, that SAI 2 is not available on a second frequency F2 (box 958). The SIB transmitted by each of the eNBs may contain different information about the availability of different SAIs. For example, based on the SIB transmitted by the eNB B to the UE, the UE may determine that SAI 1 is available on the first frequency F1 (box 954) and, further, that SAI 2 is available on the second frequency F2 (box 960). In some cases, SIBs transmitted by different eNBs may contain similar information regarding the SAIs available on certain frequencies. For example, the SIBs transmitted by eNB A and eNB C may contain similar information regarding the availability of SAIs on the first and second frequencies F1, F2 (e.g., compare boxes 952, 958 with boxes 956, 962).

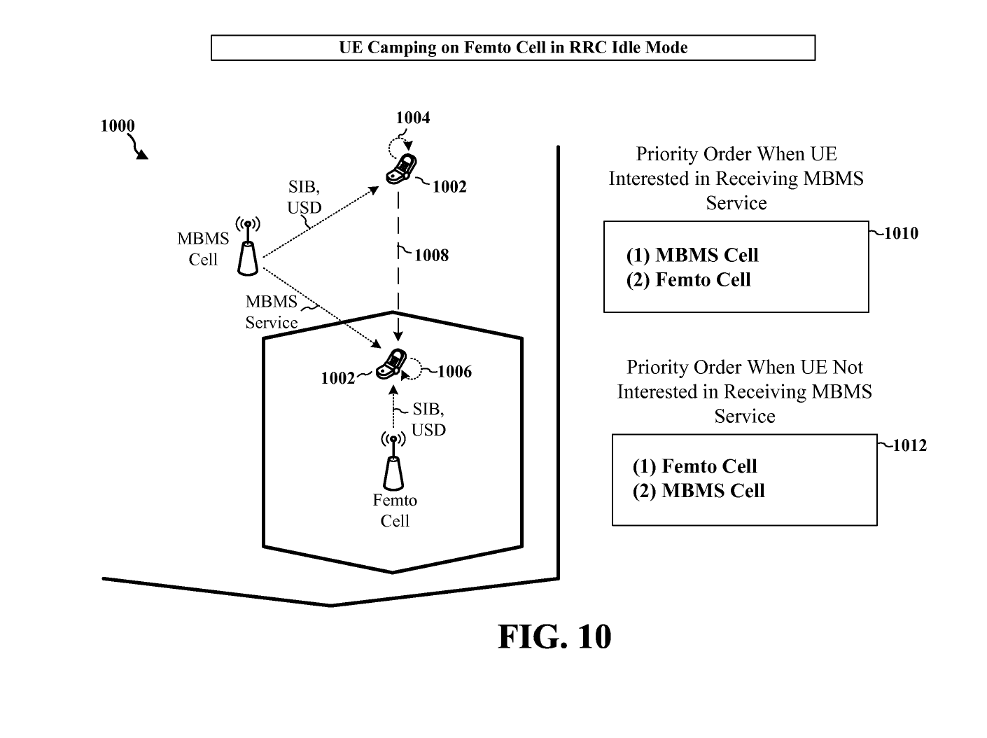

FIG. 10 is a diagram illustrating an example access network 1000. The UE 1002 may initially be in the coverage area of the MBMS cell but not in the coverage area of the femto cell. However, the UE 1002 may subsequently move 1008 into the coverage area of the femto cell. Upon moving 1008 into the coverage area of the femto cell, the UE 1002 may camp on the femto cell in an idle mode (e.g., RRC idle mode). At 1006, the UE 1002 may determine whether the UE 1002 has an interest in receiving an MBMS service from the MBMS cell. For example, the UE 1002 may determine that the UE has an interest in receiving the MBMS service when the UE 1002 is currently receiving the MBMS service or when the UE 1002 is interested in receiving the MBMS service. Also, for example, the UE 1002 may determine that the UE 1002 does not have an interest in receiving the MBMS service when the UE is not currently receiving the MBMS service and the UE is not interested in receiving the MBMS service.

At 1006, when the UE has the interest in receiving the MBMS service, the UE 1002 may adjust a priority of the MBMS cell on which the MBMS service is provided or a priority of the femto cell such that the priority of the MBMS cell is higher than the priority of the femto cell. Alternatively, when the UE 1002 does not have the interest in receiving the MBMS service, the UE 1002 may refrain from adjusting the priority of the MBMS cell or the priority of the femto cell.

For example, assume that by default a priority of the femto cell is x, where x≧0, and that a priority of the MBMS cell is y, where y≧0. In one configuration, a higher numerical value of y relative to x corresponds to a higher priority of y relative to x. In such a configuration, the UE 1002 may adjust the priority of the MBMS cell to be higher than the priority of the femto cell by setting y such that y>x. Alternatively, the UE 1002 may adjust the priority of the MBMS cell to be higher than the priority of the femto cell by setting x such that x<y. In another configuration, a lower numerical value of y relative to x corresponds to a higher priority of y relative to x. In such a configuration, the UE 1002 may adjust the priority of the MBMS cell to be higher than the priority of the femto cell by setting y such that y<x. Alternatively, the UE 1002 may adjust the priority of the MBMS cell to be higher than the priority of the femto cell by setting x such that x>y.

As shown in priority order 1010, the priority of the MBMS cell has a higher priority than the priority of the femto cell when the UE 1002 is interested in receiving the MBMS service. When the UE 1002 does not have an interest in receiving an MBMS service, the UE 1002 may refrain from adjusting the priority of the MBMS cell or the priority of the femto cell. As shown in priority order 1012, the priority of the femto cell has a higher priority than the priority of the MBMS cell when the UE 1002 is not interested in receiving the MBMS service. The priority order 1012 may be a default priority in the absence of any priority adjustments.

In some configurations, when the UE has an interest in receiving the MBMS service, at 1006, the UE 1002 may adjust the priority of the MBMS cell or the priority of the femto cell based on whether the MBMS service starts within a threshold time period. For example, assume that the threshold time period is two minutes. If the UE 1002 determines that a particular MBMS service of interest starts within two minutes, the UE 1002 may adjust the priority of the MBMS cell or the priority of the femto cell. However, if the UE 1002 determines that the particular MBMS service of interest starts after a time period greater than two minutes, the UE 1002 may refrain for a particular amount of time from adjusting the priority of the MBMS cell or the priority of the femto cell. The particular amount of time that the UE 1002 refrains from adjusting the priority may be a time difference between a time period to a start time of the MBMS service and the threshold time period. For example, if the MBMS service starts in ten minutes and the threshold time period is two minutes, the UE 1002 may refrain from adjusting the priority for eight minutes.

In some configurations, when the UE 1002 has the interest in receiving the MBMS service, at 1006, the UE 1002 may adjust the priority of the MBMS cell or the priority of the femto cell based on an indication flag indicating whether the MBMS cell has a higher priority than the priority of the femto cell. The flag indicates whether the UE can give MBMS cell higher priority than femto cell. For example, the UE 1002 may receive an MBMS_priority_over_femto_indication flag. When this flag is set to TRUE, the UE 1002 may adjust the priority of the MBMS cell to be higher than the priority of the femto cell (as shown in the priority order 1010). Alternatively, when this flag is set to FALSE, the UE 1002 may refrain from adjusting the priority of the MBMS cell to be higher than the priority of the femto cell (as shown in the priority order 1012). In one configuration, setting the MBMS_priority_over_femto_indication flag to TRUE may be equivalent to setting the MBMS_priority_over_femto_indication flag to a value of one (1), and setting the MBMS_priority_over_femto_indication flag to FALSE may be equivalent to setting the MBMS_priority_over_femto_indication flag to a value of zero (0).

In some configurations, the UE 1002 may receive system information (e.g., SIB15) and a user service description (USD) from the MBMS cell prior to moving 1008 into the coverage area of the femto cell. At 1004, the UE 1002 may cache (e.g., store) the system information and the USD, or at least some of the relevant information included in the system information and/or USD. As described in greater detail supra, a UE 1002 may receive the USD indicating available MBMS services and the TMGIs and SAIs associated with the available MBMS services. An eNB may broadcast system information (e.g., SIB15) to indicate the SAIs that are available at the current frequency (e.g., the frequency on which the SIB15 was broadcast) and at neighboring frequencies. Accordingly, based on the received USD and system information, the UE 1002 may be able to determine MBMS services that the UE 1002 can receive from the eNB. At 1006, the UE 1002 may determine the available MBMS services based on SAIs in the system information and the USD. The UE 1002 may determine whether the UE 1002 has an interest in receiving any of the available MBMS services.

In some configurations, the UE 1002 may receive the system information (e.g., SIB 15) and the USD from the femto cell subsequent to moving 1008 into the coverage area of the femto cell. For example, the UE 1002 may acquire the system information and/or USD in a unicast communication with the femto cell. At 1006, the UE may determine the available MBMS services based on the SAIs in the system information and the USD. The UE 1002 may determine whether the UE 1002 has an interest in receiving any of the available MBMS services. As described in greater detail supra, a UE 1002 may receive the USD indicating available MBMS services and the TMGIs and SAIs associated with the available MBMS services. An eNB may broadcast system information (e.g., SIB15) to indicate the SAIs that are available at the current frequency (e.g., the frequency on which the SIB15 was broadcast) and at neighboring frequencies. Accordingly, based on the received USD and SIB15, the UE 1002 may be able to determine MBMS services that the UE 1002 can receive from the eNB.

In some configurations, if the femto cell does not broadcast the system information (e.g., SIB15), the UE 1002 may use cached system information (e.g., SIB15) previously received from the MBMS cell before entering the femto cell coverage area to determine whether there is an MBMS service available in the MBMS cell and the available SAIs. In another configuration, the UE 1002 may tune to the MBMS cell to acquire the system information (e.g., SIB15). However, tuning briefly to the frequency of the MBMS cell may cause the UE 1002 to miss paging messages from the femto cell. In yet another configuration, the UE 1002 may obtain the USD using a unicast connection with the femto cell. If the femto cell broadcasts the system information (e.g., SIB15), the femto cell may refrain from broadcasting a different system information (e.g., SIB13).

In some configurations, after adjusting the priority of the MBMS cell or the priority of the femto cell, the UE 1002 may reselect the MBMS cell. For example, the UE 1002 may adjust the priority of the MBMS cell and/or the priority of the femto cell from priority order 1012 to priority order 1010. Accordingly, the adjusted priority of the MBMS cell may be higher than the adjusted priority of the femto cell. As such, the UE 1002 may reselect the MBMS cell over the femto cell when the UE is in coverage area of the MBMS cell and the femto cell.

The frequency of the MBMS cell on which the MBMS service is provided may be the same frequency as the frequency of the femto cell. When the UE 1002 is handed off to a cell at the same frequency, the hand off may be referred to as an intra-frequency handoff. Alternatively, the frequency of the MBMS cell on which the MBMS service is provided may be different from the frequency of the femto cell. When the UE 1002 is handed off to a cell at a different frequency, the hand off may be referred to as an inter-frequency handoff. In a handoff, the UE receives an indication (e.g., an RRC Connection Reconfiguration message) of the handoff from a source eNB to a target eNB. The indication includes parameters necessary for the handoff.

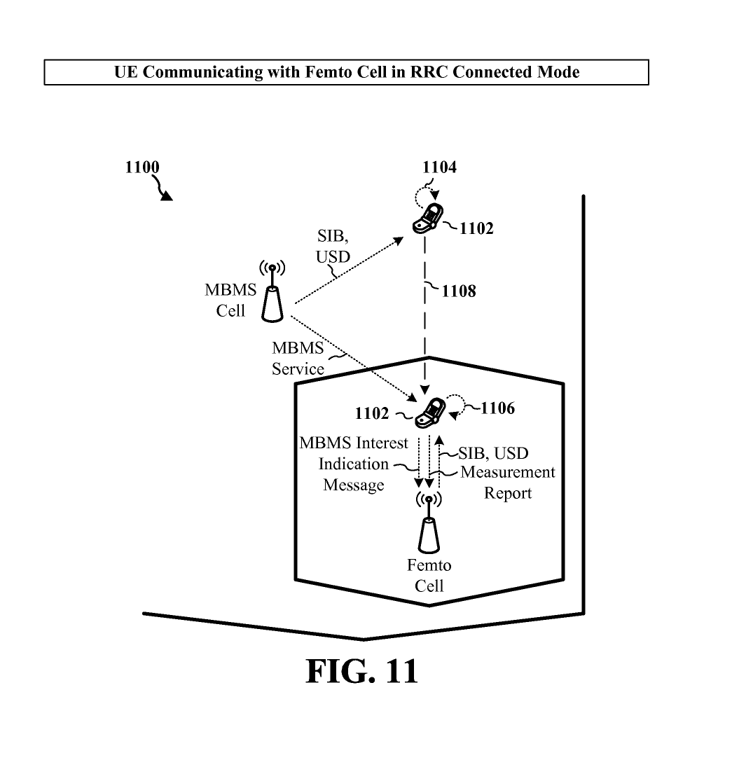

FIG. 11 is a diagram illustrating an example access network 1100. The UE 1102 may initially be in the coverage area of the MBMS cell but not in the coverage area of the femto cell. However, the UE 1102 may subsequently move 1108 into the coverage area of the femto cell. Upon moving 1108 into the coverage area of the femto cell, the UE 1102 may communicate with the femto cell in a connected mode (e.g., an RRC connected mode). As described in greater detail supra, the UE 1102 may determine whether the UE 1102 has an interest in receiving an MBMS service.

In some configurations, upon determining that the UE 1102 has an interest in receiving the MBMS service, the UE 1102 may send an MBMS interest indication message to the femto cell indicating an interest in receiving the MBMS service from the MBMS cell. In some configurations, the UE 1102 transmits the MBMS interest indication message to the femto cell only if the femto cell broadcasts certain system information (e.g., SIB15). Although the femto cell may always broadcast some system information (e.g., SIB1 and/or SIB2), the femto cell may not always broadcast other system information (e.g., SIB15), unless required to do so.

In some configurations, the MBMS cell may refrain from handing over the UE 1102 to the femto cell when the MBMS interest indication message indicates that the UE 1102 is interested in receiving the MBMS service from the MBMS cell. However, the MBMS cell may hand over the UE 1102 to the femto cell when loading at the MBMS cell exceeds a threshold. However, when the loading at the MBMS cell does not exceed the threshold, the MBMS cell may refrain from handing over the UE 1102 to the femto cell. For example, the eNB may overwrite the MBMS interest indication in case of load balancing.

In some configurations, the UE 1102 may be interested in receiving an MBMS service on either a neighbor frequency or a current frequency of the MBMS cell. The UE 1102 may send an MBMS interest indication message indicating an interest in receiving the MBMS service on that frequency. Subsequently, the UE 1102 may receive the MBMS service from the MBMS cell on the interested frequency. The service may be received on either a current frequency or a neighbor frequency.

At 1106, the UE 1102 may adjust the priority of the MBMS cell to be higher than the priority of the femto cell. Accordingly, the UE 1102 may adjust the priority of receiving the MBMS service according to priority order 1010 (see FIG. 10), wherein the priority of the MBMS cell is higher than the priority of the femto cell. Upon sending the MBMS interest indication message, at 1106, the UE may be handed off from the femto cell to the MBMS cell. The MBMS cell may be on the same or different frequency as the femto cell.

In some configurations, the UE 1102 may determine a signal quality of the communication with the femto cell. Based on the signal quality of the communication with the femto cell, the UE 1102 may send a measurement report to the femto cell. The measurement report may indicate that the MBMS cell has a higher signal quality than a signal quality of the femto cell. When the measurement report indicates that the femto cell has a lower signal quality than the signal quality of the MBMS cell by a threshold amount, the femto cell may hand over the UE 1102 to the MBMS cell. The UE 1102 may be configured to force a handover from the femto cell to the MBMS cell by reporting to the femto cell that the signal quality of the femto cell is lower than the signal quality of the MBMS cell by the threshold amount. Accordingly, at 1106, the UE 1102 may change serving cell in a handoff from the femto cell to the MBMS cell upon reporting the measurement report.

As described supra, in some configurations, the UE 1102 may receive certain system information (e.g., SIB15) and a USD from the MBMS cell prior to moving 1108 into the coverage area of the femto cell. For example, the USD may include information related to available MBMS services. In such configurations, at 1104, the UE 1102 may cache (e.g., store) the system information and the USD, or at least some of the relevant information included in the system information and/or USD. At 1106, the UE 1102 may determine the available MBMS services based on SAIs in the system information and the USD. The UE 1102 may determine whether the UE has an interest in receiving any of the available MBMS services. As described in greater detail supra, the UE 1102 may receive the USD indicating available MBMS services and the TMGIs and SAIs associated with the available MBMS services. An eNB may broadcast system information (e.g., SIB15) to indicate the SAIs that are available at the current frequency (e.g., the frequency on which the SIB15 was broadcast) and at neighboring frequencies. Accordingly, based on the received USD and SIB15, a UE may be able to determine MBMS services that the UE can receive from the eNB.

In some configurations, the UE 1102 may receive the system information (e.g., SIB 15) and the USD from the femto cell subsequent to moving 1108 into the coverage area of the femto cell and while communicating with the femto cell. For example, the UE 1102 may acquire the system information and/or USD via a unicast communication with the femto cell. At 1106, the UE may determine the available MBMS services based on the SAIs in the system information and the USD. The UE 1102 may determine whether the UE has an interest in receiving any of the available MBMS services.

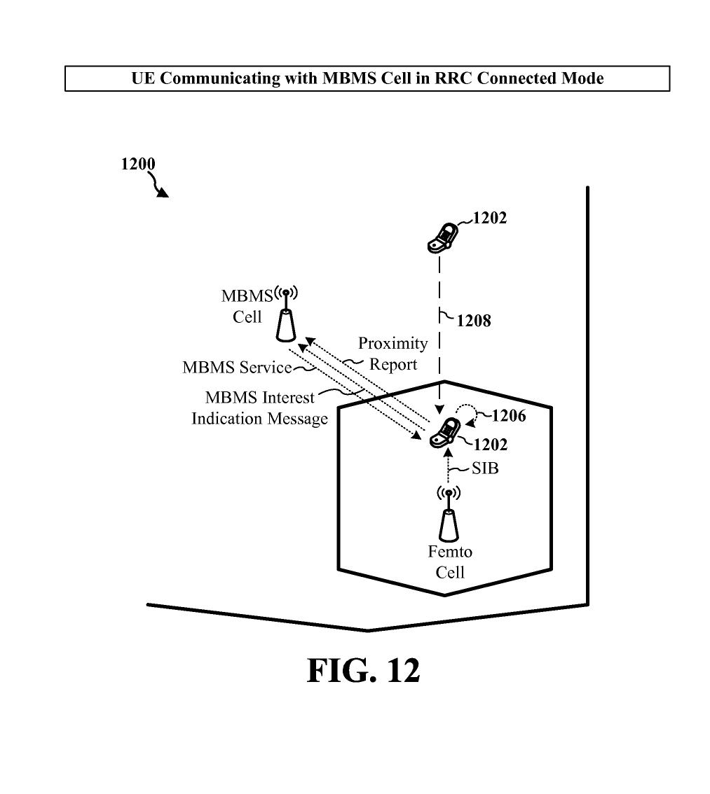

FIG. 12 is a diagram illustrating an example access network 1200. The UE 1202 may initially be in the coverage area of the MBMS cell but not the coverage area of the femto cell. The UE 1202 may communicate with the MBMS cell in a connected mode (e.g., an RRC connected mode). The UE 1202 may subsequently move 1208 into the coverage area of the femto cell. Upon moving 1208 into the coverage area of the femto cell, the UE 1202 may receive system information (e.g., a SIB) indicating the identity of the femto cell. At 1206, the UE 1202 may determine whether the UE 1202 has an interest in receiving the MBMS service from the MBMS cell. The UE may be aware that the femto cell does not broadcast the MBMS service. At 1206, the UE 1202 may adjust the priority of the MBMS cell or the priority of the femto cell based on the determination of the interest in receiving the MBMS service. Such an adjustment has been described in greater detail supra with respect to FIG. 10 and, therefore, is not being repeated. In some configurations, at 1206, the UE 1202 may refrain from sending a proximity report to the MBMS cell upon receiving the identity of the femto cell. Due to the UE 1202 refraining from sending the proximity report to the MBMS cell, the MBMS cell is unaware that the UE 1202 may be in the coverage area of the femto cell and, thus, does not hand off the UE 1202 to the femto cell. Subsequently, the UE 1202 may receive the MBMS service from the MBMS cell. The MBMS cell and the femto cell may be on the same frequency.

In some configurations, upon determining that the UE 1202 has an interest in receiving the MBMS service, the UE 1202 may send an MBMS interest indication message to the MBMS cell. The MBMS interest indication message may indicate an interest in receiving the MBMS service. The UE 1202 may adjust the priority of the MBMS cell to be higher than the priority of the femto cell, as described in greater detail supra. At 1206, the UE 1202 may send a proximity report to the MBMS cell upon receiving the identity of the femto cell. When the priority of the MBMS cell is higher than the priority of the femto cell, the UE 1202 may receive the MBMS service from the MBMS cell without being handed off to the femto cell as a result of sending the MBMS interest indication message.

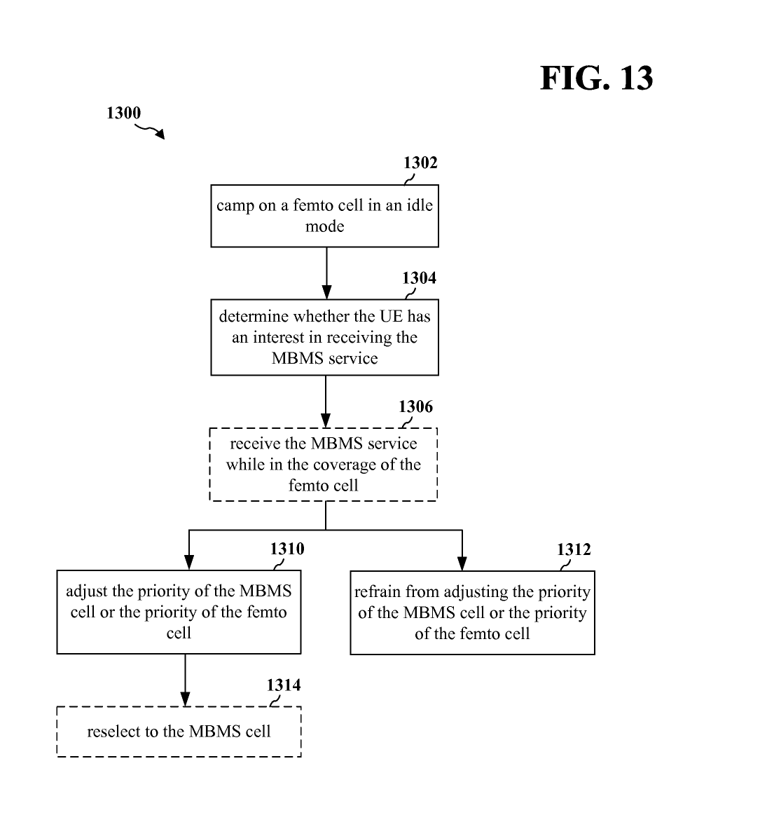

FIG. 13 is a flow chart of a first method 1300 of wireless communication of a UE. At 1302, the UE may camp on the femto cell in an idle mode. For example, referring to FIG. 10, the UE 1002 may move 1008 into the coverage area of the femto cell and camp on the femto cell in an RRC idle mode. At 1304, the UE may determine whether the UE has an interest in receiving the MBMS service from an MBMS cell. For example, referring to FIG. 10, the UE 1002 may determine that the UE 1002 has an interest in receiving the MBMS service from the MBMS cell when the UE 1002 is currently receiving the MBMS service or when the UE 1002 is interested in receiving the MBMS service. Also, for example, the UE 1002 may determine that the UE 1002 does not have an interest in receiving the MBMS service when the UE 1002 is not currently receiving the MBMS service and the UE 1002 is not interested in receiving the MBMS service. In some configurations, at 1306, the UE may receive the MBMS service while in the coverage of the femto cell. For example, referring to FIG. 10, the UE 1002 may receive the MBMS service while in the coverage of the femto cell upon determining that the UE 1002 has an interest in receiving the MBMS service.

At 1310, when the UE has the interest in receiving the MBMS service, the UE may adjust the priority of the MBMS cell to be higher than the priority of the femto cell. For example, referring to FIG. 10, when the UE has an interest in receiving the MBMS service, the UE 1002 may adjust the priority of the MBMS cell or the priority of the femto cell such that the priority corresponds to priority order 1010. In priority order 1010, the priority of the MBMS cell has a higher priority than the priority of the femto cell when the UE 1002 is interested in receiving the MBMS service. Alternatively, when the UE does not have an interest in receiving the MBMS service, at 1312, the UE may refrain from adjusting the priority of the MBMS cell or the priority of the femto cell. For example, referring to FIG. 10, when the UE 1002 does not have an interest in receiving the MBMS service, the UE 1002 may refrain from adjusting the priority of the MBMS cell or the priority of the femto cell. The priority order 1012 may be a default priority in the absence of any priority adjustments. In priority order 1012, the priority of the femto cell has a higher priority than the priority of the MBMS cell. However, if the UE does adjust the priority of the MBMS cell or the priority of the femto cell, at 1314, the UE may reselect the MBMS cell. For example, the UE 1002 may adjust the priority of the MBMS cell and/or femto cell from priority order 1012 to priority order 1010. Accordingly, the adjusted priority of the MBMS cell may be higher than the adjusted priority of the femto cell. As such, the UE 1002 may reselect the MBMS cell over the femto cell. The UE may reselect the MBMS cell over the femto cell without the eNB sending any command to the UE.

In some configurations, adjusting the priority of the MBMS cell or the priority of the femto cell is further based on whether the MBMS service starts within a threshold time period. For example, referring to FIG. 10, assume that the threshold time period is two minutes. If the UE 1002 determines that a particular MBMS service of interest starts within two minutes, the UE 1002 may adjust the priority of the MBMS cell over the femto cell. However, if the UE 1002 determines that the particular MBMS service of interest starts after a time period greater than two minutes, the UE 1002 may refrain for a particular amount of time from adjusting the priority of the MBMS cell over the femto cell. The particular amount of time that the UE 1002 refrains from adjusting the priority may be a time difference between a time period to a start time of the MBMS service and the threshold time period. For example, if the MBMS service starts in ten minutes and the threshold time period is two minutes, the UE 1002 may refrain from adjusting the priority for eight minutes.

In some configurations, adjusting the priority of the MBMS cell or the priority of the femto cell is based on an indication flag indicating whether the MBMS cell has a higher priority than the priority of the femto cell when the UE has the interest in receiving the MBMS service. For example, referring to FIG. 10, the UE 1002 may receive an MBMS_priority_over_femto_indication flag. When this flag is set to TRUE, the UE 1002 may adjust the priority of the MBMS cell to be higher than the priority of the femto cell (as shown in the priority order 1010). Alternatively, when this flag is set to FALSE, the UE 1002 may refrain from adjusting the priority of the MBMS cell to be higher than the priority of the femto cell (as shown in the priority order 1012). In one configuration, setting the MBMS_priority_over_femto_indication flag to TRUE may be equivalent to setting the MBMS_priority_over_femto_indication flag to a value of one (1), and setting the MBMS_priority_over_femto_indication flag to FALSE may be equivalent to setting the MBMS_priority_over_femto_indication flag to a value of zero (0).

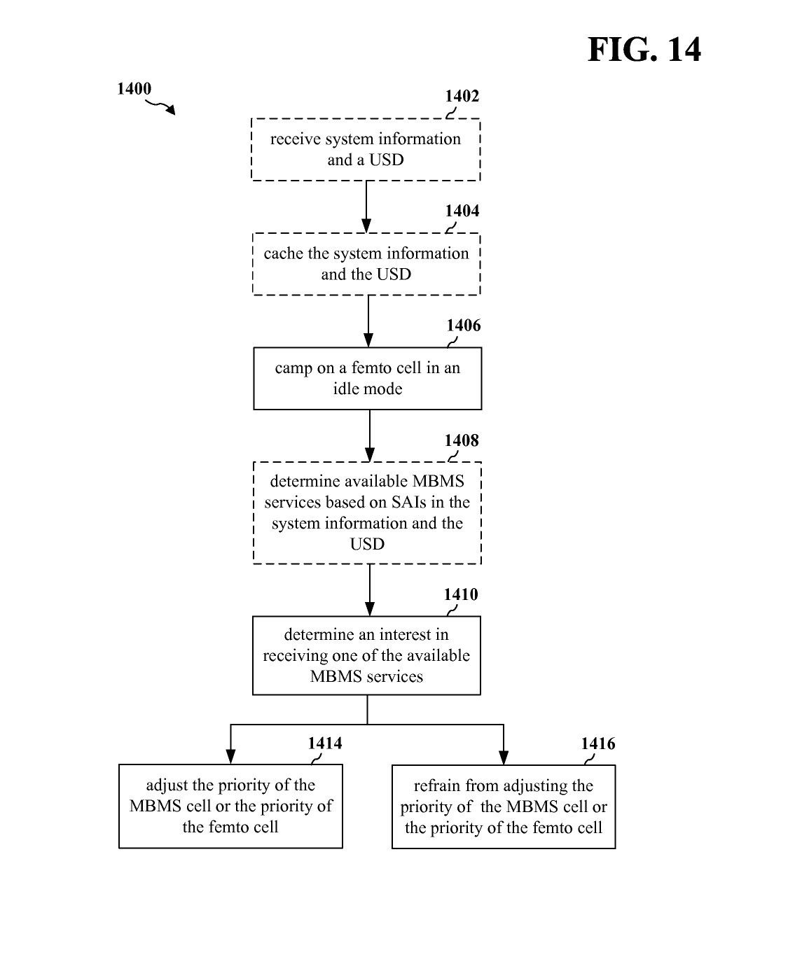

FIG. 14 is a flow chart of a second method 1400 of wireless communication of a UE. At 1402, the UE may receive system information and a USD from the MBMS cell prior to camping on the femto cell. For example, referring to FIG. 10, the UE 1002 may receive the SIB and USD from the MBMS cell prior to moving 1008 into the coverage area of the femto cell. At 1404, the UE may cache the system information and USD. For example, referring to FIG. 10, at 1004, the UE 1002 may store the system information and USD, or at least some of the relevant information included in the system information and/or USD. For example, the relevant information in the system information may be the contents in the SIB15. As another example, the relevant information in the USD may be the SAI for each TMGI. At 1406, the UE may camp on the femto cell in an idle mode (e.g., RRC idle mode), as described in greater detail supra. In some configurations, at 1408, the UE may determine available MBMS services based on SAIs in the system information and the USD. As described in greater detail supra, a UE 1002 may receive the USD indicating available MBMS services and the TMGIs and SAIs associated with the available MBMS services. An eNB may broadcast system information (e.g., SIB15) to indicate the SAIs that are available at the current frequency (e.g., the frequency on which the SIB15 was broadcast) and at neighboring frequencies. Accordingly, based on the received USD and system information, a UE may be able to determine MBMS services that the UE can receive from the eNB. At 1410, the UE may determine whether the UE has an interest in receiving one of the available MBMS services, as described in greater detail supra. At 1414, the UE may adjust the priority of the MBMS cell or the priority of the femto cell when the UE has an interest in receiving one of the available MBMS services, as described in greater detail supra. When the UE does not have an interest in receiving one of the available MBMS services, at 1416, the UE may refrain from adjusting the priority of the MBMS cell or the priority of the femto cell, as described in greater detail supra.

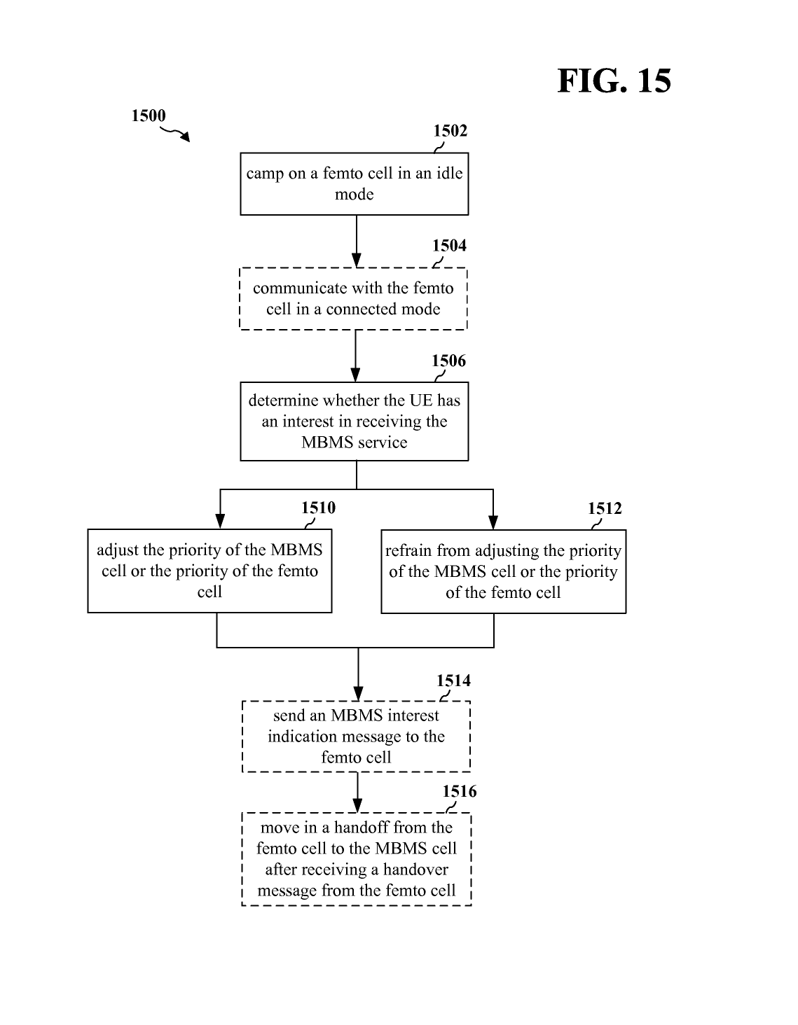

FIG. 15 is a flow chart of a third method 1500 of wireless communication of a UE. At 1502, the UE may camp on the femto cell in an idle mode. For example, referring to FIG. 11, the UE 1102 may move 1108 into the coverage area of the femto cell and camp on the femto cell in an RRC idle mode. At 1504, the UE may communicate with the femto cell in a connected mode. For example, referring to FIG. 11, the UE 1102 may communicate with the femto cell with the femto cell after moving 1108 into the coverage of the femto cell. At 1506, the UE may determine whether the UE has an interest in receiving the MBMS service, as described in greater detail supra. At 1510, the UE may adjust the priority of the MBMS cell or the priority of the femto cell when the UE has an interest in receiving the MBMS service, as described in greater detail supra. Alternatively, when the UE does not have an interest in receiving the MBMS service, at 1512, the UE may refrain from adjusting the priority of the MBMS cell or the priority of the femto cell, as described in greater detail supra. At 1514, the UE 1102 may send an MBMS interest indication message to the femto cell. For example, referring to FIG. 11, the UE 1102 may send an MBMS interest indication message to the femto cell indicating an interest in receiving the MBMS service from the MBMS cell upon determining the UE has an interest in receiving the MBMS service. At 1516, after receiving a handover message from the femto cell, the UE may be handed off from the femto cell to the MBMS cell upon sending the MBMS interest indication message.

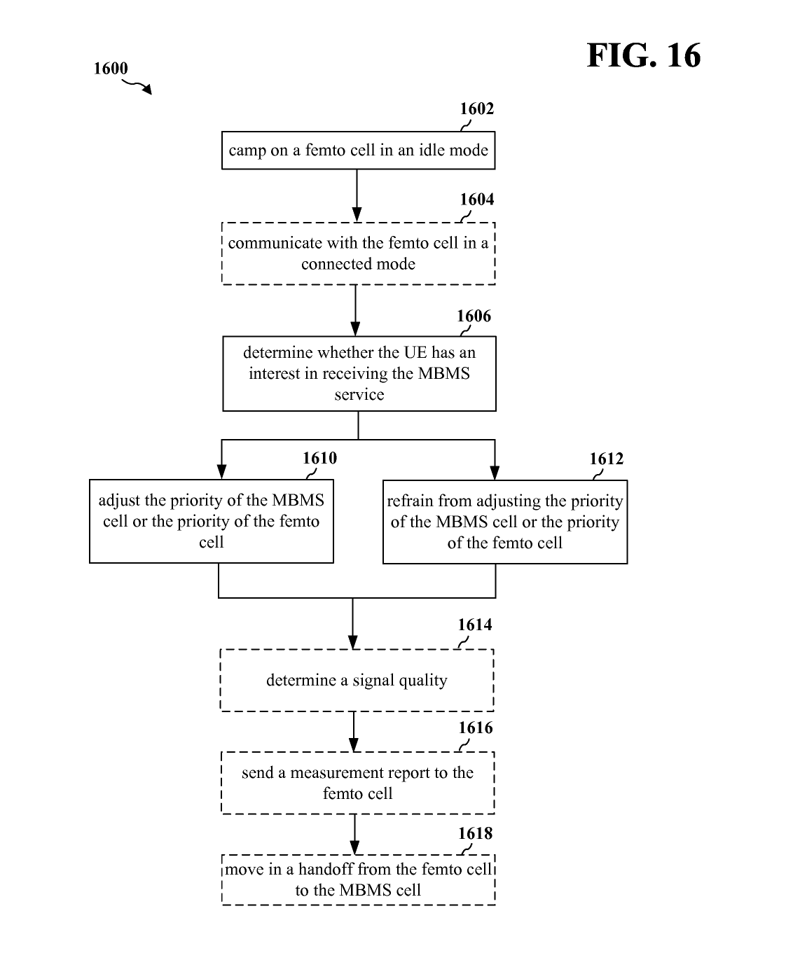

FIG. 16 is a flow chart of a fourth method 1600 of wireless communication of a UE. At 1602, the UE may camp on the femto cell in an idle mode. For example, referring to FIG. 11, the UE 1102 may move 1108 into the coverage area of the femto cell and camp on the femto cell in an RRC idle mode. (e.g., RRC idle mode). At 1604, the UE may communicate with the femto cell in a connected mode. For example, referring to FIG. 11, the UE 1102 may communicate with the femto cell with the femto cell after moving into the coverage of the femto cell. At 1606, the UE may determine whether the UE has an interest in receiving the MBMS service. At 1610, the UE may adjust the priority of the MBMS cell or the priority of the femto cell when the UE has an interest in receiving the MBMS service, as described in greater detail supra. Alternatively, when the UE does not have an interest in receiving the MBMS service, at 1612, the UE may refrain from adjusting the priority of the MBMS cell or the priority of the femto cell, as described in greater detail supra.

At 1614, the UE may determine a signal quality based on the communication with the femto cell. Based on the signal quality of the communication with the femto cell, at 1616, the UE may send a measurement report to the femto cell. At 1618, the UE may move in a handoff from the femto cell to the MBMS cell upon reporting the measurement report. Accordingly, the UE may force a handover from the femto cell to the MBMS cell by reporting to the femto cell that the signal quality of the femto cell is lower than the signal quality of the MBMS cell by a threshold amount.

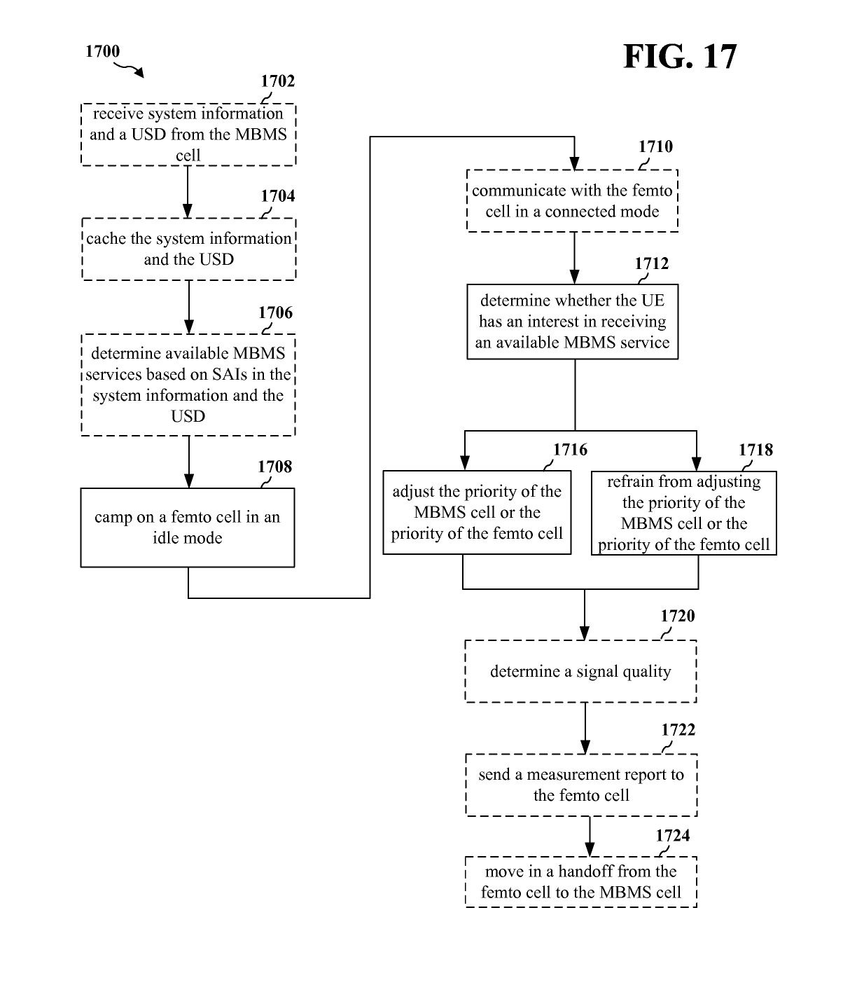

FIG. 17 is a flow chart of a fifth method 1700 of wireless communication of a UE. At 1702, the UE may receive system information and a USD from the MBMS cell prior to camping on the femto cell. For example, referring to FIG. 11, the UE 1102 may receive the SIB and USD from the MBMS cell prior to moving 1108 into the coverage area of the femto cell. At 1704, the UE may cache the system information and USD. For example, referring to FIG. 11, at 1104, the UE 1102 may store the system information and USD, or at least some of the relevant information included in the system information and/or USD. At 1706, the UE may determine available MBMS services based on SAIs in the system information and the USD. At 1708, the UE may camp on the femto cell in an idle mode (e.g., RRC idle mode), as described in greater detail supra. At 1710, the UE may communicate with the femto cell in a connected mode. For example, referring to FIG. 11, the UE 1102 may communicate with the femto cell in an RRC connected mode after moving into the coverage of the femto cell. At 1712, the UE may determine whether the UE has an interest in receiving an available MBMS service. At 1716, when the UE has an interest in receiving the MBMS service, the UE may adjust the priority of the MBMS cell or the priority of the femto cell, as described in greater detail supra. Alternatively, when the UE does not have an interest in receiving the MBMS service, at 1718, the UE may refrain from adjusting the priority of the MBMS cell or the priority of the femto cell, as described in greater detail supra. At 1720, the UE may determine a signal quality based on the communication with the femto cell. Based on the signal quality of the communication with the femto cell, at 1722, the UE may send a measurement report to the femto cell, as discussed in greater detail supra. At 1724, the UE may move in a handoff from the femto cell to the MBMS cell upon reporting the measurement report.

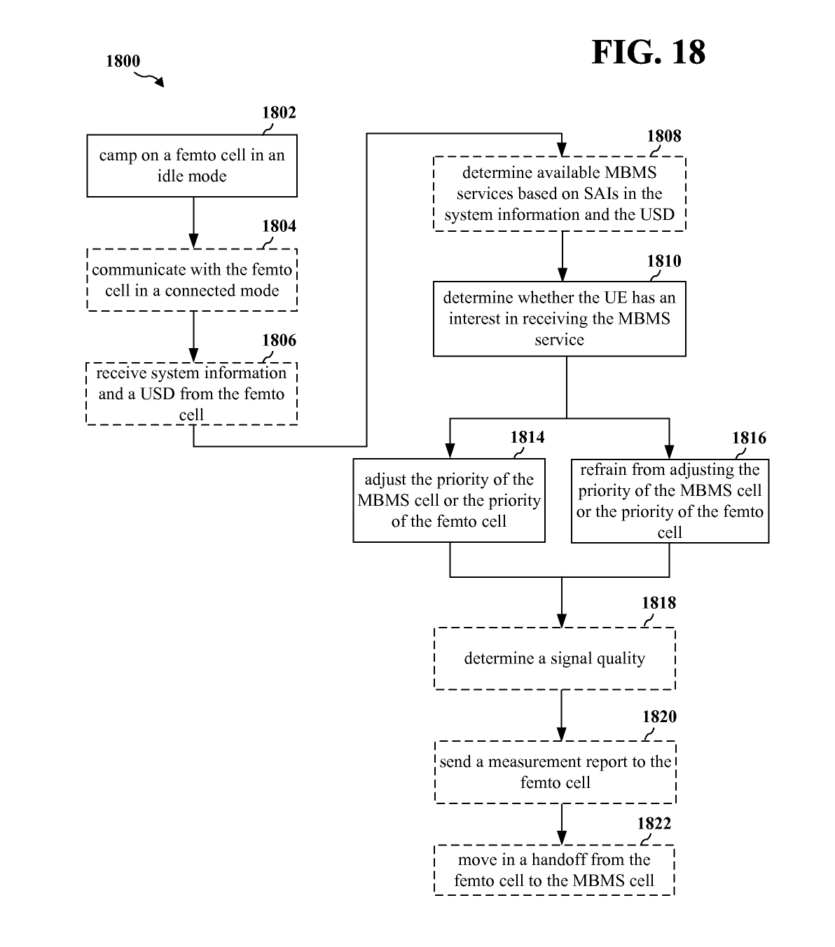

FIG. 18 is a flow chart of a sixth method 1800 of wireless communication of a UE. At 1802, the UE may camp on the femto cell in an idle mode (e.g., RRC idle mode). At 1804, the UE may communicate with the femto cell in a connected mode. For example, referring to FIG. 11, the UE 1102 may communicate with the femto cell in an RRC connected mode after moving 1108 into the coverage of the femto cell. At 1806, the UE may receive system information and a USD from the femto cell while communicating with the femto cell. For example, referring to FIG. 11, the UE 1102 may receive the SIB and USD from the femto cell after moving 1108 into the coverage area of the femto cell and while communicating with the femto cell via a broadcast. At 1808, the UE may determine available MBMS services based on SAIs in the system information and the USD, as discussed in greater detail supra. At 1810, the UE may determine whether the UE has an interest in receiving an available MBMS service, as described in greater detail supra. At 1814, the UE may adjust the priority of the MBMS cell or the priority of the femto cell when the UE has an interest in receiving the MBMS service, as described in greater detail supra. Alternatively, when the UE does not have an interest in receiving the MBMS service, at 1816, the UE may refrain from adjusting the priority of the MBMS cell or the priority of the femto cell, as described in greater detail supra. At 1818, the UE may determine a signal quality based on the communication with the femto cell. Based on the signal quality of the communication with the femto cell, at 1820, the UE may send a measurement report to the femto cell, as described in greater detail supra. At 1822, the UE may move in a handoff from the femto cell to the MBMS cell upon reporting the measurement report. The measurement report may indicate that the MBMS cell has a higher signal quality than a signal quality of the femto cell.

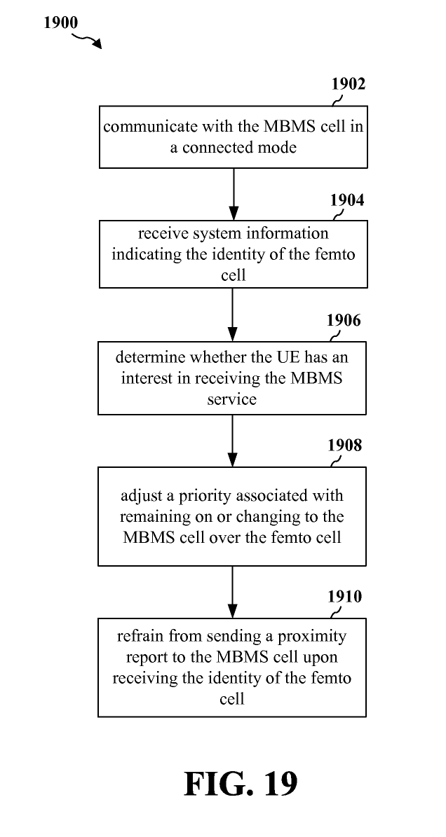

FIG. 19 is a flow chart of a seventh method 1900 of wireless communication of a UE. At 1902, the UE may communicate with the MBMS cell in a connected mode. For example, referring to FIG. 12, upon moving 1208 into the coverage area of the femto cell, the UE 1202 may communicate with the MBMS cell in an RRC connected mode. At 1904, the UE may receive system information indicating the identity of the femto cell. For example, referring to FIG. 12, the UE 1202 may receive system information (e.g., a SIB) indicating the identity of the femto cell after moving 1208 into the coverage of the femto cell. At 1906, the UE may determine whether the UE has an interest in receiving an MBMS service from the MBMS cell, as described in greater detail supra. At 1908, the UE may adjust a priority associated with remaining on or changing to the MBMS cell over the femto cell based on the determination of the interest in receiving the MBMS service, as described in greater detail supra. At 1910, the UE may refrain from sending a proximity report to the MBMS cell upon receiving the identity of the femto cell. Because the UE refrains from sending the proximity report to the MBMS cell, the MBMS cell may be unaware that the UE is in the coverage area of the femto cell and, thus, does not hand off the UE to the femto cell. Accordingly, the UE may receive MBMS service from the MBMS cell.

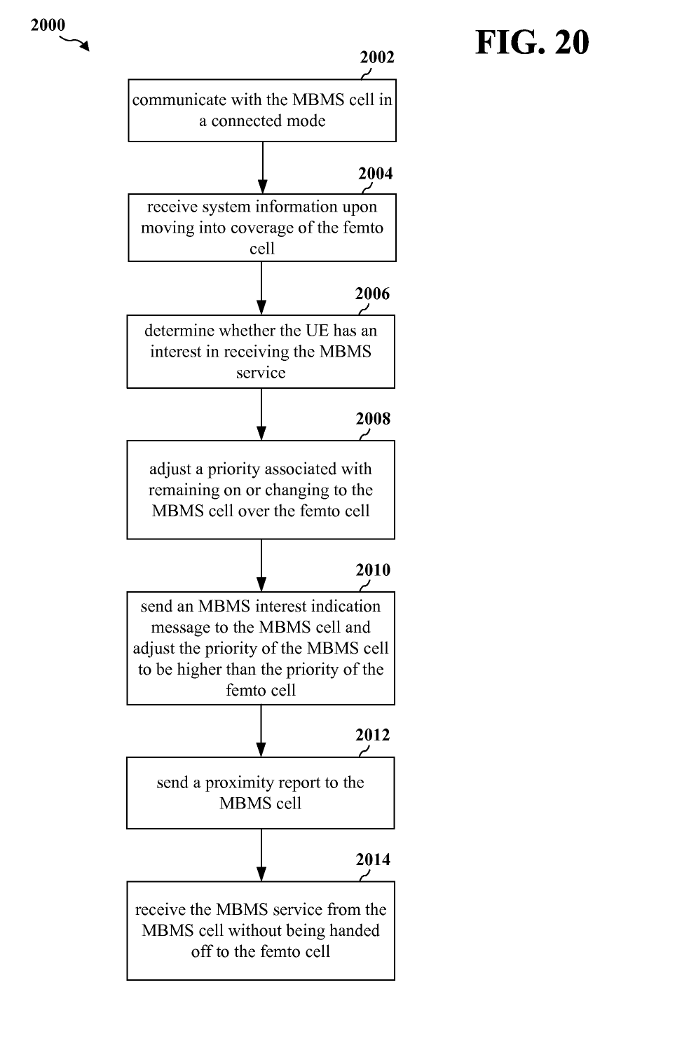

FIG. 20 is a flow chart of an eighth method 2000 of wireless communication of a UE. At 2002, the UE may communicate with the MBMS cell in a connected mode. For example, referring to FIG. 12, upon moving 1208 into the coverage area of the femto cell, the UE 1202 may communicate with the MBMS cell in an RRC connected mode. At 2004, the UE may receive system information upon indicating the identity of the femto cell. For example, referring to FIG. 12, the UE 1202 may receive system information (e.g., a SIB) indicating the identity of the femto cell after moving 1208 into the coverage of the femto cell. At 2006, the UE may determine whether the UE has an interest in receiving an MBMS service from the MBMS cell, as described in greater detail supra. At 2008, the UE may adjust a priority associated with remaining on or changing to the MBMS cell over the femto cell based on the determination of the interest in receiving the MBMS service, as described in greater detail supra. Upon determining that the UE has an interest in receiving the MBMS service, at 2010, the UE 1202 may send an MBMS interest indication message to the MBMS cell. The MBMS interest indication message may indicate an interest in receiving the MBMS service. The UE may adjust the priority of the MBMS cell to be higher than the priority of the femto cell, as described in greater detail supra. At 2012, the UE may send a proximity report to the MBMS cell upon receiving the identity of the femto cell. At 2014, the UE may receive the MBMS service from the MBMS cell without being handed off to the femto cell as a result of sending the proximity report.

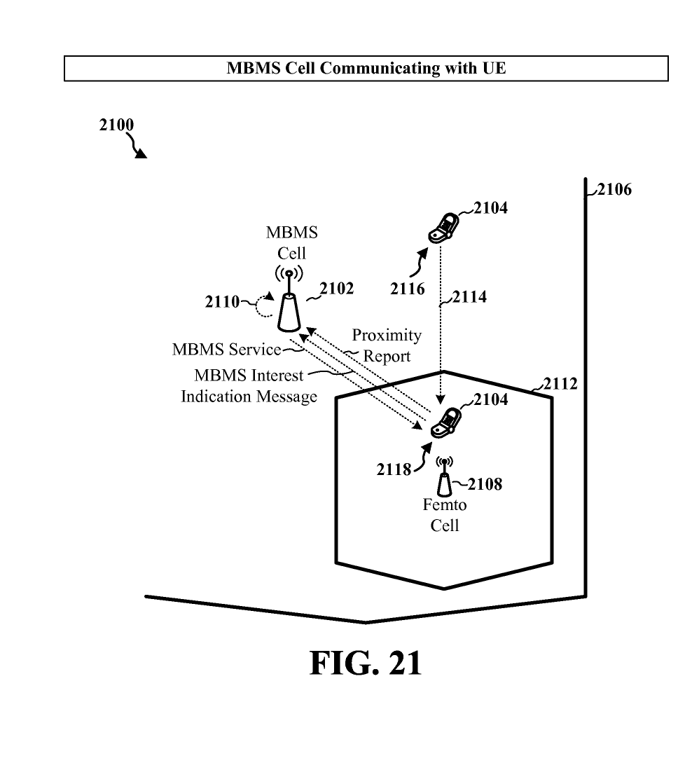

FIG. 21 is a diagram illustrating an example access network 2100 in which the MBMS cell 2102 communicates with the UE 2104. At location 2116, the UE 2104 is in the coverage area 2106 of the MBMS cell 2102 but not in the coverage area of the femto cell 2108. The UE 2104 may move 2114 from location 2116 to location 2118. At location 2118, the UE is in the coverage area 2112 of the femto cell 2108. When the UE 2104 is in the coverage area 2112 of the femto cell 2108, the MBMS cell 2102 may receive a proximity report from the UE 2104. Also, the MBMS cell 2102 may receive an MBMS interest indication message from the UE 2104. If the MBMS cell 2102 receives an MBMS interest indication message indicating an interest in receiving an MBMS service provided by the MBMS cell 2102, the MBMS cell 2102 may refrain 2110 from handing over the UE 2104 to the femto cell 2108. The MBMS cell 2102 may determine whether to hand over the UE 2104 to the femto cell 2108 further based on a loading at the MBMS cell 2102. If the MBMS cell 2102 has a loading (e.g., number of UEs served) greater than a threshold, the MBMS cell 2102 may determine to hand off the UE 2104 to the femto cell 2108 despite the UE 2104 indicating an interest in receiving an MBMS service in the MBMS interest indication message.

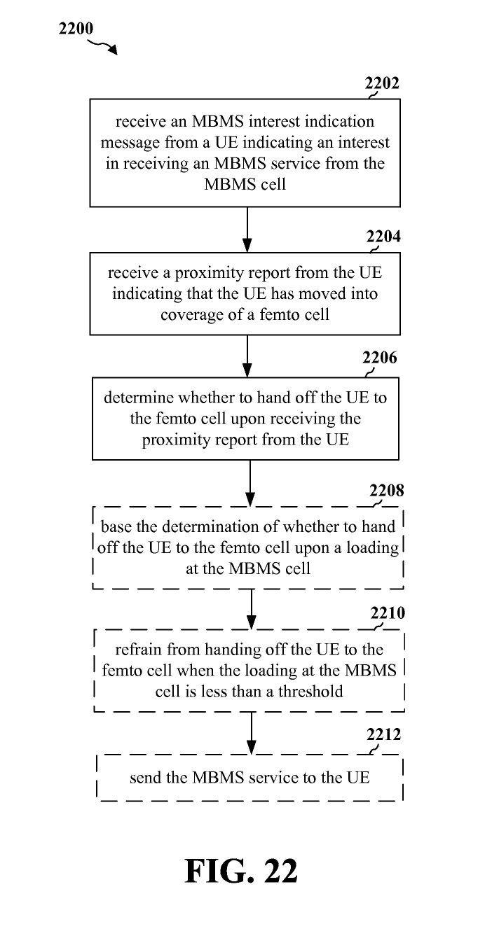

FIG. 22 is a flowchart of a method 2200 of wireless communication of an MBMS cell. In step 2202, an MBMS cell receives an MBMS interest indication message from a UE indicating an interest in receiving an MBMS service from the MBMS cell. In step 2204, the MBMS cell receives a proximity report from the UE indicating that the UE has moved into coverage area of a femto cell. In step 2206, the MBMS cell determines whether to hand off the UE to the femto cell upon receiving the proximity report from the UE. In one configuration, as shown in step 2208, the MBMS cell may base the determination of whether to hand off the UE to the femto cell upon a loading at the MBMS cell. Also, in one configuration, as shown in step 2210, the MBMS cell may refrain from handing off the UE to the femto cell when the loading at the MBMS cell is less than a threshold. Subsequently, as shown in step 2212, the MBMS cell may broadcast the MBMS service, which may be received by the UE.

For example, referring to FIG. 21, the MBMS cell 2102 receives an MBMS interest indication message from the UE 2104 to indicate an interest in receiving the MBMS service from the MBMS cell 2102. The MBMS cell 2102 receives the proximity report from the UE 2104, the proximity report indicating that the UE 2104 has moved 2114 into coverage area 2112 of the femto cell 2108. The MBMS cell 2102 determines whether to hand off the UE 2104 to the eNB 2108 of the femto cell 2108 upon receiving the proximity report from the UE 2104. In one configuration, the MBMS cell 2102 may base the determination of whether to hand off the UE 2104 to the femto cell 2108 upon the loading at the MBMS cell 2102. Also, in one configuration, the MBMS cell 2102 may refrain from handing off the UE 2104 to the femto cell 2108 when the loading at the MBMS cell 2102 is less than a threshold. Subsequently, the MBMS cell 2102 may broadcast the MBMS service, which may be received by the UE 2104.

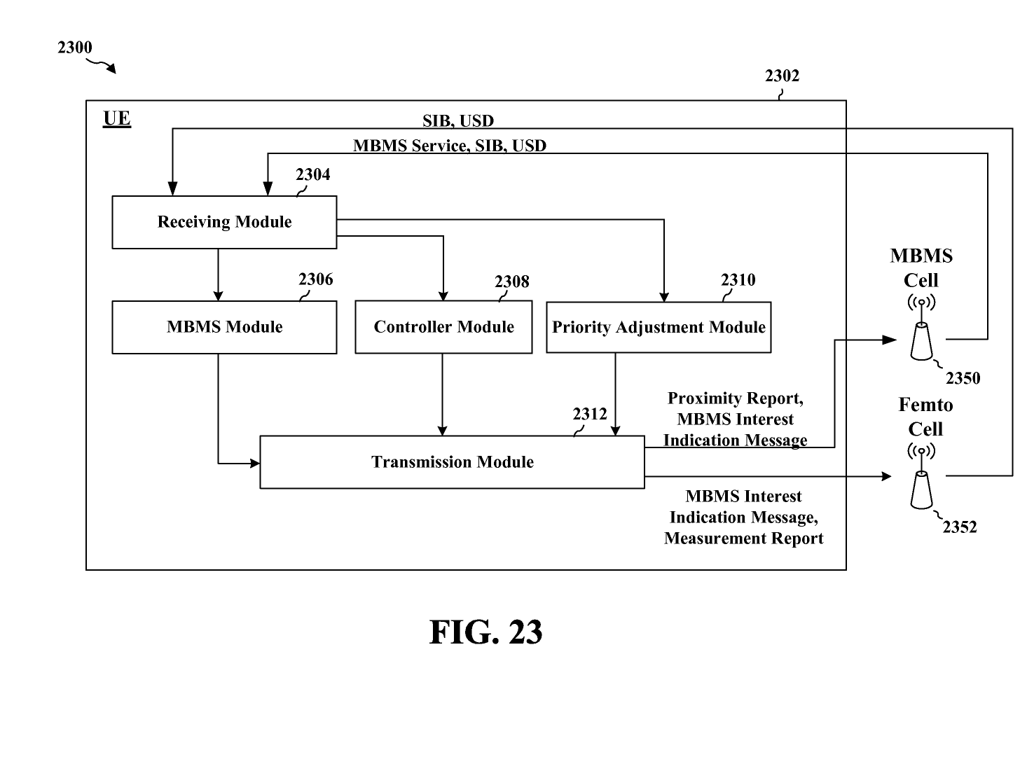

FIG. 23 is a conceptual data flow diagram 2300 illustrating the data flow between different modules/means/components in a first exemplary apparatus 2302. The apparatus may be a UE. The apparatus 2302 may include a receiving module 2304, an MBMS module 2306, a controller module 2308, a priority determination & adjustment module 2310, and a transmission module 2312. The controller module 2308 may be configured to camp on a femto cell in an idle mode. The MBMS module 2306 may be configured to determine whether the UE has an interest in receiving an MBMS service from an MBMS cell. The priority adjustment module 2310 may be further configured to adjust a priority of the MBMS cell on which the MBMS service is provided or the priority of the femto cell such that the priority of the MBMS cell is higher than the priority of the femto cell when the UE has the interest in receiving the MBMS service. The controller module 2308 may be further configured to refrain from adjusting the priority of the MBMS cell or the priority of the femto cell when the UE does not have the interest in receiving the MBMS service.

In some configurations, the receiving module 2304 may be configured to receive the MBMS service from the MBMS cell while in a coverage of the femto cell upon determining the UE has an interest in receiving the MBMS service, and the priority adjusting module 2310 may be further configured to adjust the priority of the MBMS cell to be higher than a priority of the femto cell. In some configurations, when the UE has an interest in receiving the MBMS service, the priority adjustment module 2310 may be further configured to adjust the priority of the MBMS cell or the priority of the femto cell further based on whether the MBMS service starts within a threshold time period. In some configurations, the MBMS module 2306 may be further configured to determine that the UE has the interest in receiving the MBMS service when the UE is currently receiving the MBMS service or when the UE is interested in receiving the MBMS service, and determine that the UE does not have the interest in receiving the MBMS service when the UE is not currently receiving the MBMS service and the UE is not interested in receiving the MBMS service. In some configurations, the priority adjustment module 2310 may be further configured to adjust the priority of the MBMS cell or the priority of the femto cell further based on an indication flag indicating whether the MBMS cell has a higher priority than the femto cell when the UE has the interest in receiving the MBMS service. In some configurations, the frequency of the MBMS cell on which the MBMS service is provided is a same frequency as the frequency of the femto cell. In some configurations, the frequency of the MBMS cell on which the MBMS service is provided is a different frequency from the frequency of the femto cell.

In some configurations, the receiving module 2304 may be further configured to receive system information and a USD from the MBMS cell prior to camping on the femto cell. The controlling module 2308 may be further configured to cache the system information and the USD. The MBMS module 2306 may be configured to determine available MBMS services based on SAIs in the system information and the USD. The priority adjustment module 2310 may be further configured to determine an interest in receiving one of the available MBMS services. In some configurations, the receiving module 2304 may be further configured to receive system information and a USD from the femto cell subsequent to camping on the femto cell. The MBMS module 2306 may be further configured to determine available MBMS services based on SAIs in the system information and the USD. The MBMS module may be further configured to determine an interest in receiving one of the available MBMS services. In some configurations, the controller module 2308 may be further configured to reselect to the MBMS cell upon the adjusting the priority of the MBMS cell or the priority of the femto cell.

In some configurations, the controller module 2308 may be further configured to communicate with the femto cell in a connected mode. The transmission module 2312 may be further configured to send an MBMS interest indication message to the femto cell indicating an interest in receiving the MBMS service from the MBMS cell upon determining the UE has an interest in receiving the MBMS service, and the priority adjustment module 2310 may be further configured to adjust the priority of the MBMS cell to be higher than the priority of the femto cell. After the receiving module 2304 receives a handover message from the femto cell, the controller module 2308 may be further configured to move in a handoff from the femto cell to the MBMS cell upon sending the MBMS interest indication message. In some configurations, the frequency of the MBMS cell on which the MBMS service is provided is a same frequency as a frequency of the femto cell. In some configurations, wherein the frequency of the MBMS cell on which the MBMS service is provided is a different frequency as a frequency of the femto cell.

In some configurations, the controller module 2308 may be further configured to communicate with the femto cell in a connected mode. The controller module 2308 may be further configured to determine a signal quality based on the communication with the femto cell. The transmission module 2312 may be further configured to send a measurement report to the femto cell reporting that the MBMS cell has a higher signal quality than a signal quality of the femto cell, wherein the femto cell hands over the UE to the MBMS cell when the UE reports to the femto cell a signal quality of the femto cell lower than the measured signal quality in the measurement report. The controlling module 2308 may be further configured to move in a handoff from the femto cell to the MBMS cell upon reporting the measurement report.

In some configurations, the receiving module 2304 may be further configured to receive system information and a USD from the MBMS cell prior to communicating with the femto cell. The controlling module 2308 may be further configured to cache the system information and the USD. The controller module may be further configured to determine available MBMS services based on SAIs in the system information and the USD. The MBMS module 2306 may be configured to determine an interest in receiving one of the available MBMS services.

In some configurations, the receiving module 2304 may be further configured to receive system information and a USD from the femto cell while communicating with the femto cell. The MBMS module 2306 may be further configured to determine available MBMS services based on SAIs in the system information and the USD. The MBMS module 2306 may be further configured to determine an interest in receiving one of the available MBMS services.

In some configurations, the controller module 2308 may be further configured to communicate with an MBMS cell in a connected mode. The receiving module 2304 may be further configured to receive system information upon moving into coverage of a femto cell, the system information indicating an identity of the femto cell. The MBMS module 2306 may be further configured to determine whether the UE has an interest in receiving an MBMS service from the MBMS cell. The priority adjustment module 2310 may be further configured to adjust a priority of the MBMS cell or the priority of the femto cell based on the determination of the interest in receiving the MBMS service. The transmission module 2312 may be further configured to refrain from sending a proximity report to the MBMS cell upon receiving the identity of the femto cell.

In some configurations, the controlling module 2308 may be further configured to communicate with an MBMS cell in a connected mode. The receiving module 2304 may be further configured to receive system information upon moving into coverage of a femto cell, the system information indicating an identity of the femto cell. The MBMS module 2306 may be further configured to determine whether the UE has an interest in receiving an MBMS service from the MBMS cell. The priority adjustment module 2310 may be further configured to adjust a priority of the MBMS cell or the priority of the femto cell based on the determination of the interest in receiving the MBMS service. The transmission module 2312 may be further configured to send an MBMS interest indication message to the MBMS cell indicating an interest in receiving the MBMS service upon determining the UE has an interest in receiving the MBMS service, and the priority adjustment module 2310 may be further configured to adjust the priority of the MBMS cell to be higher than the priority of the femto cell. The transmission module 2312 may be further configured to send a proximity report to the MBMS cell upon receiving the identity of the femto cell. The receiving module 2304 may be further configured to receive the MBMS service from the MBMS cell without being handed off to the femto cell as a result of sending the proximity report.

The apparatus may include additional modules that perform each of the steps of the algorithm in the aforementioned flow charts of FIGS. 13-20. As such, each step in the aforementioned flow charts of FIGS. 13-20 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

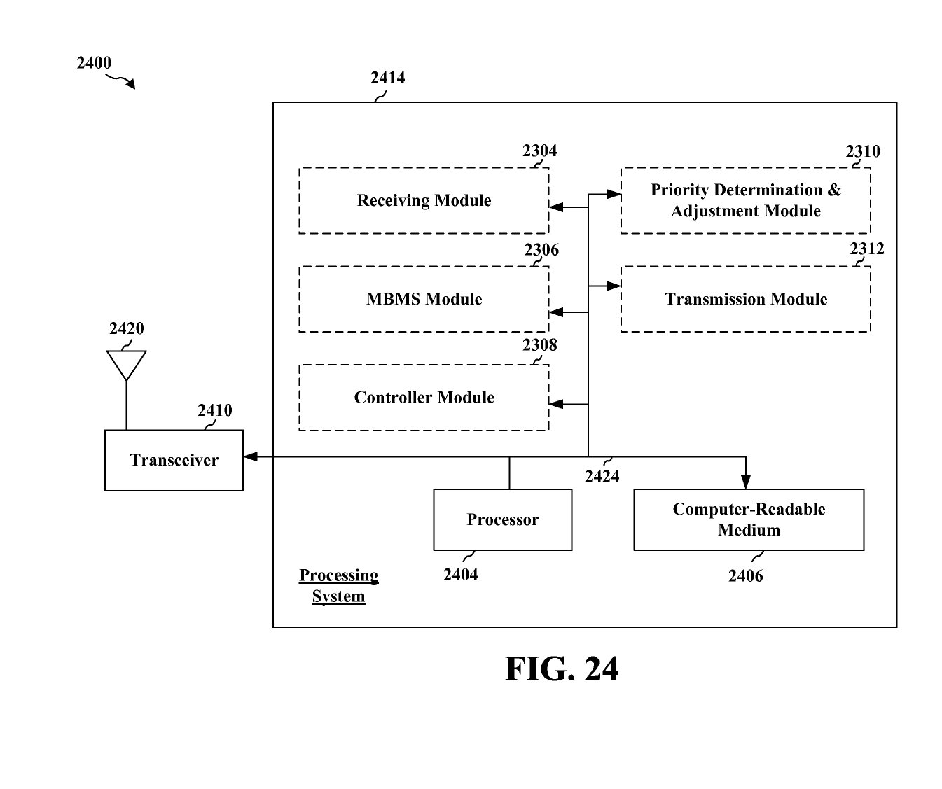

FIG. 24 is a diagram 2400 illustrating an example of a hardware implementation for an apparatus 2302 employing a processing system 2414. The processing system 2414 may be implemented with a bus architecture, represented generally by the bus 2424. The bus 2424 may include any number of interconnecting buses and bridges depending on the specific application of the processing system 2414 and the overall design constraints. The bus 2424 links together various circuits including one or more processors and/or hardware modules, represented by the processor 2404, the modules 2304, 2306, 2308, 2310, 2312, and the computer-readable medium 2406. The bus 2424 may also link various other circuits such as timing sources, peripherals, voltage regulators, and power management circuits, which are well known in the art, and therefore, will not be described any further.

The processing system 2414 may be coupled to a transceiver 2410. The transceiver 2410 is coupled to one or more antennas 2420. The transceiver 2410 provides a means for communicating with various other apparatus over a transmission medium. The transceiver 2410 receives a signal from the one or more antennas 2420, extracts information from the received signal, and provides the extracted information to the processing system 2414, specifically the receiving module 2304. In addition, the transceiver 2410 receives information from the processing system 2414, specifically the transmission module 2312, and based on the received information, generates a signal to be applied to the one or more antennas 2420. The processing system 2414 includes a processor 2404 coupled to a computer-readable medium 2406. The processor 2404 is responsible for general processing, including the execution of software stored on the computer-readable medium 2406. The software, when executed by the processor 2404, causes the processing system 2414 to perform the various functions described supra for any particular apparatus. The computer-readable medium 2406 may also be used for storing data that is manipulated by the processor 2404 when executing software. The processing system further includes at least one of the modules 2304, 2306, 2308, 2310, and 2312. The modules may be software modules running in the processor 2404, resident/stored in the computer readable medium 2406, one or more hardware modules coupled to the processor 2404, or some combination thereof. The processing system 2414 may be a component of the UE 650 and may include the memory 660 and/or at least one of the TX processor 668, the RX processor 656, and the controller/processor 659.

In one configuration, the apparatus 2302 for wireless communication may be a UE. The UE includes means for camping on a femto cell in an idle mode. The UE further includes means for determining whether the UE has an interest in receiving the MBMS service from an MBMS cell. The UE further includes means for adjusting a priority of the MBMS cell on which the MBMS service is provided or a priority of the femto cell such that the priority of the MBMS cell is higher than the priority of the femto cell when the UE has the interest in receiving the MBMS service. The UE further includes means for refraining from adjusting the priority of the MBMS cell or the priority of the femto cell when the UE does not have the interest in receiving the MBMS service.

In some configurations, the UE may further include means for receiving the MBMS service from the MBMS cell while in a coverage of the femto cell upon determining the UE has an interest in receiving the MBMS service and adjusting the priority of the MBMS cell to be higher than the priority of the femto cell. In some configurations, when the UE has an interest in receiving the MBMS service, the UE may further include means for adjusting the priority of the MBMS cell or the priority of the femto cell further based on whether the MBMS service starts within a threshold time period.

In some configurations, the UE may further include means for determining that the UE has the interest in receiving the MBMS service when the UE is currently receiving the MBMS service or when the UE is interested in receiving the MBMS service. The UE may further include means for determining that the UE does not have the interest in receiving the MBMS service when the UE is not currently receiving the MBMS service and the UE is not interested in receiving the MBMS service. In some configurations, the UE may further include means for adjusting the priority of the MBMS cell over the femto cell further based on an indication flag indicating whether the MBMS cell has a higher priority than the femto cell when the UE has the interest in receiving the MBMS service. In some configurations, the frequency of the MBMS cell on which the MBMS service is provided is a same frequency as the frequency of the femto cell. In some configurations, the frequency of the MBMS cell on which the MBMS service is provided is a different frequency from the frequency of the femto cell.

In some configurations, the UE may further include means for receiving system information and a USD from the MBMS cell prior to camping on the femto cell. The UE may further include means for caching the system information and the USD. The UE may further include means for determining available MBMS services based on SAIs in the system information and the USD. The UE may further include means for determining an interest in receiving one of the available MBMS services. In some configurations, the UE may further include means for receiving system information and a USD from the femto cell subsequent to camping on the femto cell. The UE may further include means for determining available MBMS services based on SAIs in the system information and the USD. The UE may further include means for determining an interest in receiving one of the available MBMS services. In some configurations, the UE may further include means for reselecting to the MBMS cell upon the adjusting the priority of the MBMS cell or the priority of the femto cell. In some configurations, the UE may further include means for communicating with the femto cell in a connected mode. The UE may further include means for sending an MBMS interest indication message to the femto cell indicating an interest in receiving the MBMS service from the MBMS cell upon determining the UE has an interest in receiving the MBMS service and adjusting the priority of the MBMS cell to be higher than the priority of the femto cell. The UE may further include means for moving in a handoff from the femto cell to the MBMS cell upon sending the MBMS interest indication message.

In some configurations, the frequency of the MBMS cell on which the MBMS service is provided is a same frequency as a frequency of the femto cell. In some configurations, the frequency of the MBMS cell on which the MBMS service is provided is a different frequency as a frequency of the femto cell. In some configurations, the UE may further include means for communicating with the femto cell in a connected mode. The UE may further include means for determining a signal quality based on the communication with the femto cell. The UE may further include means for sending a measurement report to the femto cell reporting that the MBMS cell has a higher signal quality than a signal quality of the femto cell, wherein the femto cell hands over the UE to the MBMS cell when the UE reports to the femto cell a signal quality of the femto cell lower than the measured signal quality in the measurement report. The UE may further include means for moving in a handoff from the femto cell to the MBMS cell upon reporting the measurement report.

In some configurations, the UE may further include means for receiving system information and a USD from the MBMS cell prior to communicating with the femto cell. The UE may further include means for caching the system information and the USD. The UE may further include means for determining available MBMS services based on SAIs in the system information and the USD. The UE may further include means for determining an interest in receiving one of the available MBMS services. In some configurations, the UE may further include means for receiving system information and a USD from the femto cell while communicating with the femto cell. The UE may further include means for determining available MBMS services based on SAIs in the system information and the USD. The UE may further include means for determining an interest in receiving one of the available MBMS services. In another embodiment, the UE includes means for communicating with an MBMS cell in a connected mode. The UE further includes means for receiving system information upon moving into coverage of a femto cell, the system information indicating an identity of the femto cell. The UE further includes means for determining whether the UE has an interest in receiving an MBMS service from the MBMS cell. The UE includes means for adjusting a priority of the MBMS cell or a priority of the femto cell based on the determination of the interest in receiving the MBMS service. The UE includes means for refraining from sending a proximity report to the MBMS cell upon receiving the identity of the femto cell.

In another embodiment, the UE includes means for communicating with a Multimedia Broadcast Multicast Service (MBMS) cell in a connected mode. The UE further includes means for receiving system information upon moving into coverage of a femto cell, the system information indicating an identity of the femto cell. The UE further includes means for determining whether the UE has an interest in receiving an MBMS service from the MBMS cell. The UE further includes means for adjusting a priority of the MBMS cell or a priority of the femto cell based on the determination of the interest in receiving the MBMS service. The UE further includes means for sending an MBMS interest indication message to the MBMS cell indicating an interest in receiving the MBMS service upon determining the UE has an interest in receiving the MBMS service and adjusting the priority of the MBMS cell to be higher than the priority of the femto cell. The UE further includes means for sending a proximity report to the MBMS cell upon receiving the identity of the femto cell. The UE further includes means for receiving the MBMS service from the MBMS cell without being handed off to the femto cell as a result of sending the proximity report.

The aforementioned means may be one or more of the aforementioned modules of the apparatus 2302 and/or the processing system 2314 of the apparatus 2302 configured to perform the functions recited by the aforementioned means. As described supra, the processing system 2314 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

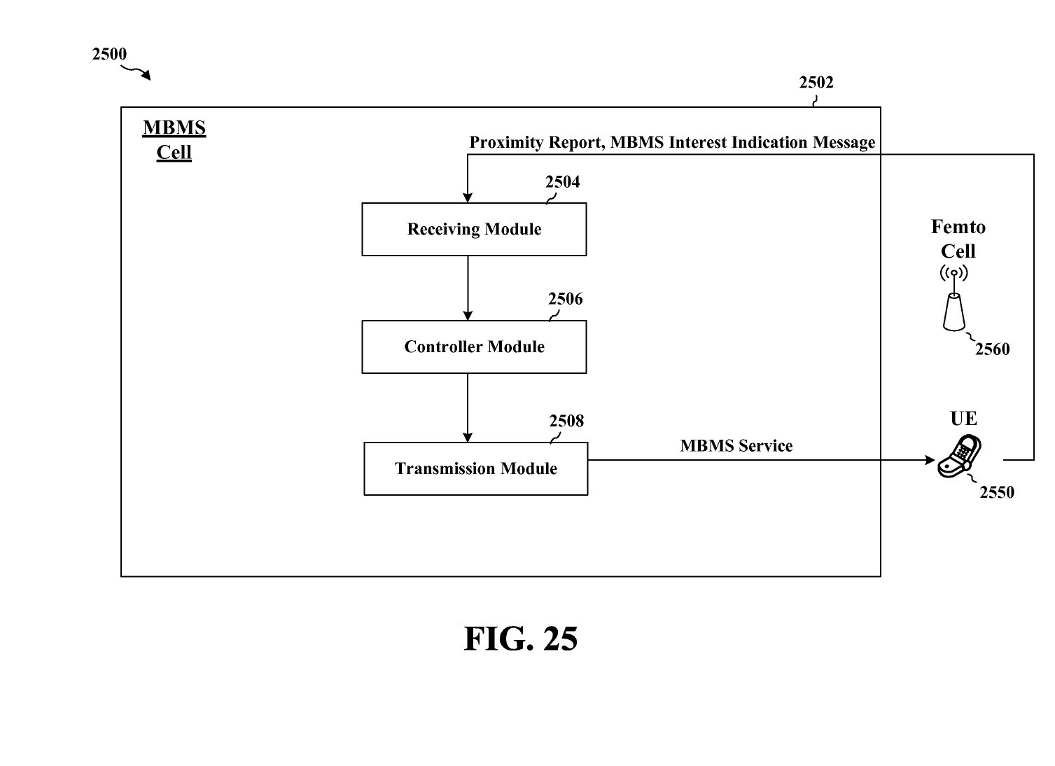

FIG. 25 is a conceptual data flow diagram 2500 illustrating the data flow between different modules/means/components in an exemplary apparatus 2502. The apparatus may be an MBMS cell 2502. The apparatus 2502 may include a receiving module 2504, a controller module 2506, and a transmission module 2508.

The receiving module 2504 is configured to receive an MBMS interest indication message from the UE 2550 indicating an interest in receiving an MBMS service from an MBMS cell 2502. The receiving module 2504 is further configured to receive a proximity report from the UE 2550 indicating that the UE 2550 has moved into coverage of a femto cell 2560.

The controller module 2506 may be configured to determine whether to hand off the UE 2550 to the femto cell 2560 upon receiving the proximity report from the UE 2550. The controller module 2506 may be configured to determine whether to hand off the UE 2550 to the femto cell 2560 upon receiving the proximity report from the UE 2550. The controller module 2506 may be configured to determine whether to hand off the UE 2550 to the femto cell 2560 based upon a loading at the MBMS cell 2502. The controller module 2506 may be configured to refrain from handing off the UE 2550 to the femto cell 2560 when the loading at the MBMS cell 2502 is less than a threshold.

The transmission module 2508 may be configured to send the MBMS service to the UE 2550.

The apparatus may include additional modules that perform each of the steps of the algorithm in the aforementioned flow chart of FIG. 22. As such, each step in the aforementioned flow chart of FIG. 22 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

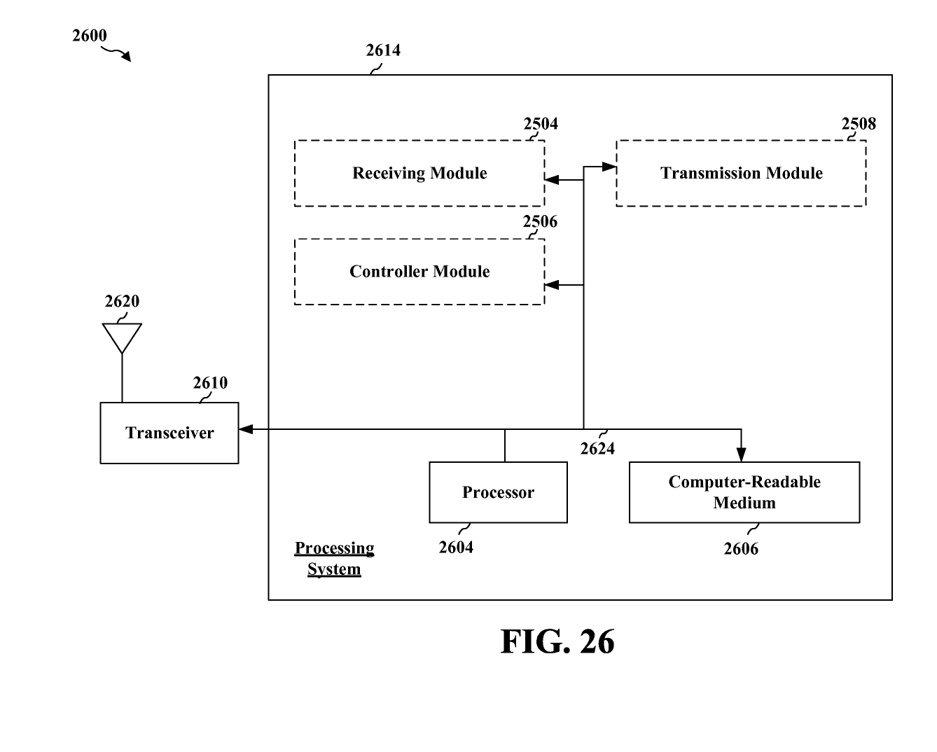

FIG. 26 is a diagram 2600 illustrating an example of a hardware implementation for an apparatus 2602 employing a processing system 2614. The processing system 2614 may be implemented with a bus architecture, represented generally by the bus 2624. The bus 2624 may include any number of interconnecting buses and bridges depending on the specific application of the processing system 2614 and the overall design constraints. The bus 2624 links together various circuits including one or more processors and/or hardware modules, represented by the processor 2604, the modules 2504, 2506, 2508, and the computer-readable medium 2606. The bus 2624 may also link various other circuits such as timing sources, peripherals, voltage regulators, and power management circuits, which are well known in the art, and therefore, will not be described any further.

The processing system 2614 may be coupled to a transceiver 2610. The transceiver 2610 is coupled to one or more antennas 2620. The transceiver 2610 provides a means for communicating with various other apparatus over a transmission medium. The transceiver 2610 receives a signal from the one or more antennas 2620, extracts information from the received signal, and provides the extracted information to the processing system 2614, specifically the receiving module 2504. In addition, the transceiver 2610 receives information from the processing system 2614, specifically the transmission module 2508, and based on the received information, generates a signal to be applied to the one or more antennas 2620. The processing system 2614 includes a processor 2604 coupled to a computer-readable medium 2606. The processor 2604 is responsible for general processing, including the execution of software stored on the computer-readable medium 2606. The software, when executed by the processor 2604, causes the processing system 2614 to perform the various functions described supra for any particular apparatus. The computer-readable medium 2606 may also be used for storing data that is manipulated by the processor 2604 when executing software. The processing system further includes at least one of the modules 2504, 2506, and 2508. The modules may be software modules running in the processor 2604, resident/stored in the computer readable medium 2606, one or more hardware modules coupled to the processor 2604, or some combination thereof. The processing system 2614 may be a component of the eNB 610 and may include the memory 676 and/or at least one of the TX processor 616, the RX processor 670, and the controller/processor 675.

In one configuration, the apparatus 2502 for wireless communication may be an MBMS cell. The MBMS cell includes means for receiving an MBMS interest indication message from a UE indicating an interest in receiving an MBMS service from an MBMS cell, means for receiving a proximity report from the UE indicating that the UE has moved into coverage of a femto cell, and means for determining whether to hand off the UE to the femto cell upon receiving the proximity report from the UE. The means for determining whether to hand off the UE to the femto cell may be configured such that determining whether to hand off the UE to the femto cell is based upon a loading at the MBMS cell. The MBMS cell may further include means for refraining from handing off the UE to the femto cell when the loading at the MBMS cell is less than a threshold, and means for sending the MBMS service to the UE.

The aforementioned means may be one or more of the aforementioned modules of the apparatus 2502 and/or the processing system 2614 of the apparatus 2502 configured to perform the functions recited by the aforementioned means. As described supra, the processing system 2614 may include the TX Processor 616, the RX Processor 670, and the controller/processor 675. As such, in one configuration, the aforementioned means may be the TX Processor 616, the RX Processor 670, and the controller/processor 675 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication of a user equipment (UE), comprising:
camping, in an idle mode, on a femto cell;
determining whether the UE has an interest in receiving a Multimedia Broadcast Multicast Service (MBMS) service from an MBMS cell;
adjusting a priority of the MBMS cell on which the MBMS service is provided or the priority of the femto cell such that the priority of the MBMS cell is higher than the priority of the femto cell when the UE has the interest in receiving the MBMS service; and
refraining from adjusting the priority of the MBMS cell or the priority of the femto cell when the UE does not have the interest in receiving the MBMS service.

2. The method of claim 1, further comprising receiving the MBMS service from the MBMS cell while in a coverage area of the femto cell after determining the UE has an interest in receiving the MBMS service and adjusting the priority.

3. The method of claim 1, wherein when the UE has an interest in receiving the MBMS service, the adjusting the priority is further based on whether the MBMS service starts within a threshold time period.

4. The method of claim 1, wherein the determining whether the UE has the interest in receiving the MBMS service comprises:
determining that the UE has the interest in receiving the MBMS service when the UE is receiving or is interested in receiving the MBMS service; and
determining that the UE does not have the interest in receiving the MBMS service when the UE is not receiving and is not interested in receiving the MBMS service.

5. The method of claim 1, wherein the adjusting the priority is further based on an indication flag indicating whether the MBMS cell has a higher priority than the femto cell when the UE has the interest in receiving the MBMS service.

6. The method of claim 1, wherein the frequency of the MBMS cell on which the MBMS service is provided is a same frequency as the frequency of the femto cell.

7. The method of claim 1, wherein the frequency of the MBMS cell on which the MBMS service is provided is a different frequency from the frequency of the femto cell.

8. The method of claim 1, further comprising:
receiving system information and a user service description (USD) from the MBMS cell prior to camping on the femto cell;
determining available MBMS services based on service area identities (SAIs) in the received system information and the USD; and
determining an interest in receiving the MBMS service when the MBMS service is one of the available MBMS services.

9. The method of claim 1, further comprising:
receiving system information and a user service description (USD) from the femto cell subsequent to camping on the femto cell;
determining available MBMS services based on service area identities (SAIs) in the received system information and the USD; and
determining an interest in receiving the MBMS service when the MBMS service is one of the available MBMS services.

10. The method of claim 1, further comprising reselecting to the MBMS cell upon the adjusting the priority of the MBMS cell or the priority of the femto cell.

11. The method of claim 1, further comprising:
entering a connected mode with the femto cell;
sending an MBMS interest indication message to the femto cell indicating an interest in receiving the MBMS service from the MBMS cell upon determining the UE has an interest in receiving the MBMS service and adjusting the priority of the MBMS cell to be higher than the priority of the femto cell; and
after receiving a handover message from the femto cell, moving in a handoff from the femto cell to the MBMS cell upon sending the MBMS interest indication message.

12. The method of claim 1, further comprising:
entering a connected mode with the femto cell;
determining a signal quality of the femto cell based on the communication with the femto cell; and
forcing a handover from the femto cell to the MBMS cell by reporting to the femto cell that the signal quality of the femto cell is lower than a signal quality of the MBMS cell by a threshold amount.

13. The method of claim 12, further comprising:
receiving system information and a user service description (USD) from the MBMS cell prior to communicating with the femto cell;
determining available MBMS services based on service area identities (SAIs) in the system information and the USD; and
determining an interest in receiving the MBMS service when the MBMS service is one of the available MBMS services.

14. The method of claim 12, further comprising:
receiving system information and a user service description (USD) from the femto cell while communicating with the femto cell;
determining available MBMS services based on service area identities (SAIs) in the system information and the USD; and
determining an interest in receiving the MBMS service when the MBMS service is one of the available MBMS services.

15. An apparatus for wireless communication, the apparatus being a user equipment (UE), comprising:
means for camping, in an idle mode, on a femto cell;
means for determining whether the UE has an interest in receiving a Multimedia Broadcast Multicast Service (MBMS) service from an MBMS cell;
means for adjusting a priority of the MBMS cell on which the MBMS service is provided or the priority of the femto cell such that the priority of the MBMS cell is higher than the priority of the femto cell when the UE has the interest in receiving the MBMS service; and
means for refraining from adjusting the priority of the MBMS cell or the priority of the femto cell when the UE does not have the interest in receiving the MBMS service.

16. The apparatus of claim 15, further comprising means for receiving the MBMS service from the MBMS cell while in a coverage of the femto cell after determining the UE has an interest in receiving the MBMS service and adjusting the priority.

17. The apparatus of claim 15, wherein when the UE has an interest in receiving the MBMS service, the means for adjusting the priority is further configured to adjust the priority based on whether the MBMS service starts within a threshold time period.

18. The apparatus of claim 15, wherein the means for determining whether the UE has the interest in receiving the MBMS service is configured to:
determine that the UE has the interest in receiving the MBMS service when the UE is receiving or is interested in receiving the MBMS service; and
determine that the UE does not have the interest in receiving the MBMS service when the UE is not receiving and is not interested in receiving the MBMS service.

19. The apparatus of claim 15, wherein the means for adjusting the priority is further configured to adjust the priority based on an indication flag indicating whether the MBMS cell has a higher priority than the femto cell when the UE has the interest in receiving the MBMS service.

20. The apparatus of claim 15, wherein the frequency of the MBMS cell on which the MBMS service is provided is a same frequency as the frequency of the femto cell.

21. The apparatus of claim 15, wherein the frequency of the MBMS cell on which the MBMS service is provided is a different frequency from the frequency of the femto cell.

22. The apparatus of claim 15, further comprising:
means for receiving system information and a user service description (USD) from the MBMS cell prior to camping on the femto cell;
means for determining available MBMS services based on service area identities (SAIs) in the received system information and the USD; and
means for determining an interest in receiving the MBMS service when the MBMS service is one of the available MBMS services.

23. The apparatus of claim 15, further comprising:
means for receiving system information and a user service description (USD) from the femto cell subsequent to camping on the femto cell;
means for determining available MBMS services based on service area identities (SAIs) in the received system information and the USD; and
means for determining an interest in receiving the MBMS service when the MBMS service is one of the available MBMS services.

24. The apparatus of claim 15, further comprising means for reselecting to the MBMS cell upon the adjusting the priority of the MBMS cell or the priority of the femto cell.

25. The apparatus of claim 15, further comprising:
means for entering a connected mode with the femto cell;
means for sending an MBMS interest indication message to the femto cell indicating an interest in receiving the MBMS service from the MBMS cell upon determining the UE has an interest in receiving the MBMS service and adjusting the priority of the MBMS cell to be higher than the priority of the femto cell; and
means for moving in a handoff from the femto cell to the MBMS cell upon sending the MBMS interest indication message after receiving a handover message from the femto cell.

26. The apparatus of claim 15, further comprising:
means for entering a connected mode with the femto cell;
means for determining a signal quality of the femto cell based on the communication with the femto cell; and
means for forcing a handover from the femto cell to the MBMS cell by reporting to the femto cell that the signal quality of the femto cell is lower than a signal quality of the MBMS cell by a threshold amount.

27. The apparatus of claim 26, further comprising:
means for receiving system information and a user service description (USD) from the MBMS cell prior to communicating with the femto cell;
means for determining available MBMS services based on service area identities (SAIs) in the system information and the USD; and
means for determining an interest in receiving the MBMS service when the MBMS service is one of the available MBMS services.

28. The apparatus of claim 26, further comprising:
means for receiving system information and a user service description (USD) from the femto cell while communicating with the femto cell;
means for determining available MBMS services based on service area identities (SAIs) in the system information and the USD; and
means for determining an interest in receiving the MBMS service when the MBMS service is one of the available MBMS services.

29. An apparatus for wireless communication, comprising:
a memory; and
at least one processor coupled to the memory and configured to:
camp, in an idle mode, on a femto cell;
determine whether the UE has an interest in receiving a Multimedia Broadcast Multicast Service (MBMS) service from an MBMS cell;
adjust a priority of the MBMS cell on which the MBMS service is provided or the priority of the femto cell such that the priority of the MBMS cell is higher than the priority of the femto cell when the UE has the interest in receiving the MBMS service; and
refrain from adjusting the priority of the MBMS cell or the priority of the femto cell when the UE does not have the interest in receiving the MBMS service.

30. A computer program product, comprising:
a computer-readable medium comprising code for:
camping, in an idle mode, on a femto cell;
determining whether the UE has an interest in receiving a Multimedia Broadcast Multicast Service (MBMS) service from an MBMS cell;
adjusting a priority of the MBMS cell on which the MBMS service is provided or the priority of the femto cell such that the priority of the MBMS cell is higher than the priority of the femto cell when the UE has the interest in receiving the MBMS service; and
refraining from adjusting the priority of the MBMS cell or the priority of the femto cell when the UE does not have the interest in receiving the MBMS service.
